(19) United States
(12) Patent Application Publication
(10) Pub. No.: US 2024/0405943 A1
(43) Pub. Date: Dec. 5, 2024

(54) SOUNDING REFERENCE SIGNAL RESOURCE INDICATOR SIGNALING FOR SPATIAL DIVISION MULTIPLEXING COMMUNICATIONS

(71) Applicant: QUALCOMM Incorporated, San Diego, CA (US)

(72) Inventors: Yitao CHEN, San Marcos, CA (US); Mostafa KHOSHNEVISAN, San Diego, CA (US); Xiaoxia ZHANG, San Diego, CA (US); Jing SUN, San Diego, CA (US); Tao LUO, San Diego, CA (US); Peter GAAL, San Diego, CA (US); Fang YUAN, Beijing (CN); Wooseok NAM, San Diego, CA (US)

(21) Appl. No.: 18/693,358

(22) PCT Filed: Nov. 17, 2021
(86) PCT No.: PCT/CN2021/131110

§ 371 Date: Mar. 19, 2024

(51) Int. Cl. H04L 5/00; H04W 72/1268; H04W 72/231; H04W 72/56

(52) U.S. Cl. CPC H04L 5/0051; H04W 72/1268; H04W 72/231; H04W 72/56

(57) ABSTRACT

Various aspects of the present disclosure generally relate to wireless communication. In some aspects, a user equipment (UE) may receive configuration information associated with a first sounding reference signal (SRS) resource set, including a first quantity of SRS resources, and a second SRS resource set, including a second quantity of SRS resources. The UE may receive downlink control information (DCI) scheduling a spatial division multiplexing communication, the DCI indicating a first one or more SRS resources, associated with a first set of layers, and a second one or more SRS resources, associated with a second set of layers, from the first SRS resource set and/or the second SRS resource set based on: a dynamic switching indicator, a first SRS resource indicator (SRI), a second SRI, the first quantity of SRS resources, the second quantity of SRS resources, and/or a maximum rank. Numerous other aspects are described.

### FIELD OF THE DISCLOSURE

Aspects of the present disclosure generally relate to wireless communication and to techniques and apparatuses for sounding reference signal (SRS) resource indicator (SRI) signaling for spatial division multiplexing (SDM) communications.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more base stations that support communication for a user equipment (UE) or multiple UEs. A UE may communicate with a base station via downlink communications and uplink communications. “Downlink” (or “DL”) refers to a communication link from the base station to the UE, and “uplink” (or “UL”) refers to a communication link from the UE to the base station.

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a user equipment (UE) for wireless communication. The user equipment may include a memory and one or more processors coupled to the memory. The one or more processors may be configured to receive, from a base station, configuration information associated with a first sounding reference signal (SRS) resource set and a second SRS resource set, wherein the first SRS resource set includes a first quantity of SRS resources and the second SRS resource set includes a second quantity of SRS resources. The one or more processors may be configured to receive, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.

Some aspects described herein relate to a method of wireless communication performed by a UE. The method may include receiving, from a base station, configuration information associated with a first SRS resource set and a second SRS resource set, wherein the first SRS resource set includes a first quantity of SRS resources and the second SRS resource set includes a second quantity of SRS resources. The method may include receiving, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Some aspects described herein relate to a non-transitory computer-readable medium that stores a set of instructions for wireless communication by a UE. The set of instructions, when executed by one or more processors of the UE, may cause the UE to receive, from a base station, configuration information associated with a first SRS resource set and a second SRS resource set, wherein the first SRS resource set includes a first quantity of SRS resources and the second SRS resource set includes a second quantity of SRS resources. The set of instructions, when executed by one or more processors of the UE, may cause the UE to receive, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Some aspects described herein relate to an apparatus for wireless communication. The apparatus may include means for receiving, from a base station, configuration information associated with a first SRS resource set and a second SRS resource set, wherein the first SRS resource set includes a first quantity of SRS resources and the second SRS resource set includes a second quantity of SRS resources. The apparatus may include means for receiving, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Some aspects described herein relate to a base station for wireless communication. The base station may include a memory and one or more processors coupled to the memory. The one or more processors may be configured to transmit, to a UE, configuration information associated with a first SRS resource set and a second SRS resource set, wherein the first SRS resource set includes a first quantity of SRS resources and the second SRS resource set includes a second quantity of SRS resources. The one or more processors may be configured to transmit, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Some aspects described herein relate to a method of wireless communication performed by a base station. The method may include transmitting, to a UE, configuration information associated with a first SRS resource set and a second SRS resource set, wherein the first SRS resource set includes a first quantity of SRS resources and the second SRS resource set includes a second quantity of SRS resources. The method may include transmitting, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Some aspects described herein relate to a non-transitory computer-readable medium that stores a set of instructions for wireless communication by a base station. The set of instructions, when executed by one or more processors of the base station, may cause the base station to transmit, to a UE, configuration information associated with a first SRS resource set and a second SRS resource set, wherein the first SRS resource set includes a first quantity of SRS resources and the second SRS resource set includes a second quantity of SRS resources. The set of instructions, when executed by one or more processors of the base station, may cause the base station to transmit, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Some aspects described herein relate to an apparatus for wireless communication. The apparatus may include means for transmitting, to a UE, configuration information associated with a first SRS resource set and a second SRS resource set, wherein the first SRS resource set includes a first quantity of SRS resources and the second SRS resource set includes a second quantity of SRS resources. The apparatus may include means for transmitting, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a base station in communication with a user equipment (UE) in a wireless network, in accordance with the present disclosure.

FIG. 3 illustrates an example logical architecture of a distributed radio access network (RAN), in accordance with the present disclosure.

FIG. 4 is a diagram illustrating an example of multiple transmission reception point (TRP) communication, in accordance with the present disclosure.

FIG. 5 is a diagram illustrating an example of sounding reference signal (SRS) resource sets, in accordance with the present disclosure.

FIG. 6 is a diagram illustrating an example of dynamic switching between single-TRP (sTRP) communications and multiple-TRP (mTRP) communications, in accordance with the present disclosure.

FIGS. 7 and 8 are diagrams illustrating examples associated with SRS resource indicator (SRI) signaling for spatial division multiplexing (SDM) communications, in accordance with the present disclosure.

FIGS. 9 and 10 are diagrams illustrating example processes associated with SRI signaling for SDM communications, in accordance with the present disclosure.

FIGS. 11 and 12 are diagrams of example apparatuses for wireless communication, in accordance with the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

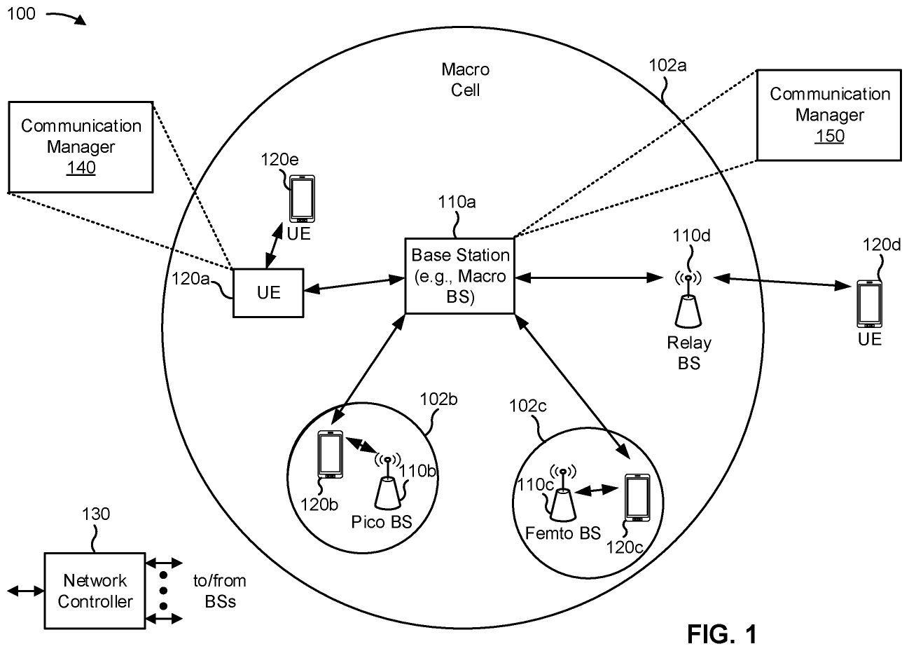

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more base stations 110 (shown as a BS 110a, a BS 110b, a BS 110c, and a BS 110d), a user equipment (UE) 120 or multiple UEs 120 (shown as a UE 120a, a UE 120b, a UE 120c, a UE 120d, and a UE 120e), and/or other network entities. A base station 110 is an entity that communicates with UEs 120. A base station 110 (sometimes referred to as a BS) may include, for example, an NR base station, an LTE base station, a Node B, an eNB (e.g., in 4G), a gNB (e.g., in 5G), an access point, and/or a transmission reception point (TRP). Each base station 110 may provide communication coverage for a particular geographic area. In the Third Generation Partnership Project (3GPP), the term “cell” can refer to a coverage area of a base station 110 and/or a base station subsystem serving this coverage area, depending on the context in which the term is used.

A base station 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscription. A femto cell may cover a relatively small geographic area (e.g., a home) and may allow restricted access by UEs 120 having association with the femto cell (e.g., UEs 120 in a closed subscriber group (CSG)). A base station 110 for a macro cell may be referred to as a macro base station. A base station 110 for a pico cell may be referred to as a pico base station. A base station 110 for a femto cell may be referred to as a femto base station or an in-home base station. In the example shown in FIG. 1, the BS 110a may be a macro base station for a macro cell 102a, the BS 110b may be a pico base station for a pico cell 102b, and the BS 110c may be a femto base station for a femto cell 102c. A base station may support one or multiple (e.g., three) cells.

In some examples, a cell may not necessarily be stationary, and the geographic area of the cell may move according to the location of a base station 110 that is mobile (e.g., a mobile base station). In some examples, the base stations 110 may be interconnected to one another and/or to one or more other base stations 110 or network nodes (not shown) in the wireless network 100 through various types of backhaul interfaces, such as a direct physical connection or a virtual network, using any suitable transport network.

The wireless network 100 may include one or more relay stations. A relay station is an entity that can receive a transmission of data from an upstream station (e.g., a base station 110 or a UE 120) and send a transmission of the data to a downstream station (e.g., a UE 120 or a base station 110). A relay station may be a UE 120 that can relay transmissions for other UEs 120. In the example shown in FIG. 1, the BS 110d (e.g., a relay base station) may communicate with the BS 110a (e.g., a macro base station) and the UE 120d in order to facilitate communication between the BS 110a and the UE 120d. A base station 110 that relays communications may be referred to as a relay station, a relay base station, a relay, or the like.

The wireless network 100 may be a heterogeneous network that includes base stations 110 of different types, such as macro base stations, pico base stations, femto base stations, relay base stations, or the like. These different types of base stations 110 may have different transmit power levels, different coverage areas, and/or different impacts on interference in the wireless network 100. For example, macro base stations may have a high transmit power level (e.g., 5 to 40 watts) whereas pico base stations, femto base stations, and relay base stations may have lower transmit power levels (e.g., 0.1 to 2 watts).

A network controller 130 may couple to or communicate with a set of base stations 110 and may provide coordination and control for these base stations 110. The network controller 130 may communicate with the base stations 110 via a backhaul communication link. The base stations 110 may communicate with one another directly or indirectly via a wireless or wireline backhaul communication link.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, and/or any other suitable device that is configured to communicate via a wireless medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a base station, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the base station 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHZ, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHZ, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

In some aspects, the UE 120 may include a communication manager 140. As described in more detail elsewhere herein, the communication manager 140 may receive, from a base station, configuration information associated with a first sounding reference signal (SRS) resource set and a second SRS resource set, wherein the first SRS resource set includes a first quantity of SRS resources and the second SRS resource set includes a second quantity of SRS resources; and receive, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication. Additionally, or alternatively, the communication manager 140 may perform one or more other operations described herein.

In some aspects, the base station 110 may include a communication manager 150. As described in more detail elsewhere herein, the communication manager 150 may transmit, to a UE, configuration information associated with a first SRS resource set and a second SRS resource set, wherein the first SRS resource set includes a first quantity of SRS resources and the second SRS resource set includes a second quantity of SRS resources; and transmit, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication. Additionally, or alternatively, the communication manager 150 may perform one or more other operations described herein.

As indicated above, FIG. 1 is provided as an example. Other examples may differ from what is described with regard to FIG. 1.

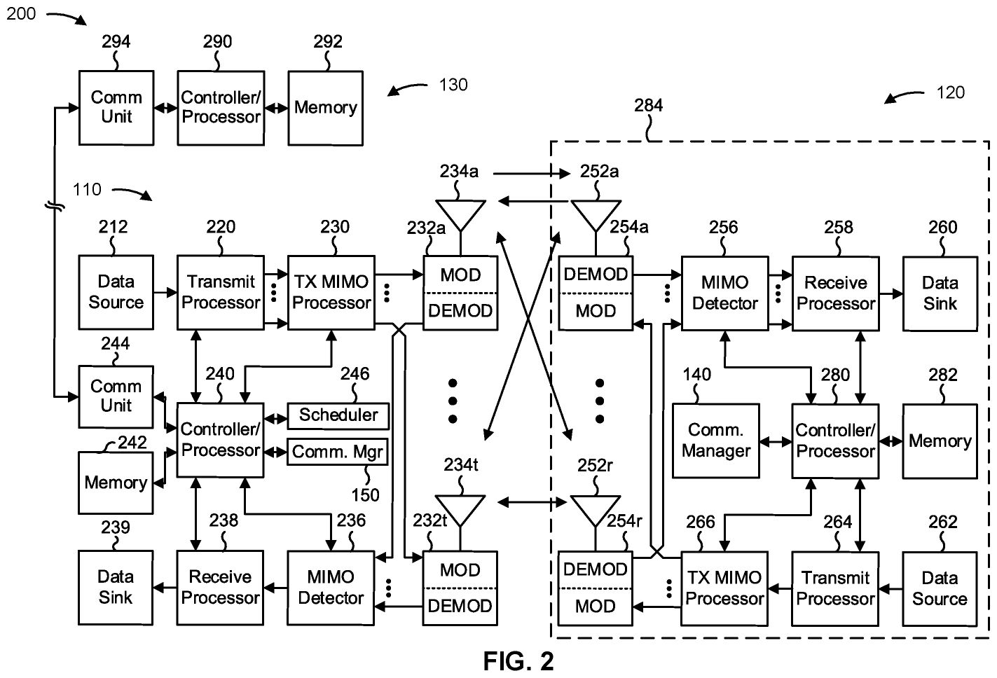

FIG. 2 is a diagram illustrating an example 200 of a base station 110 in communication with a UE 120 in a wireless network 100, in accordance with the present disclosure. The base station 110 may be equipped with a set of antennas 234a through 234t, such as T antennas (T≥1). The UE 120 may be equipped with a set of antennas 252a through 252r, such as R antennas (R≥1).

At the base station 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The base station 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the base station 110 and/or other base stations 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the base station 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

Antenna elements and/or sub-elements may be used to generate beams. “Beam” may refer to a directional transmission such as a wireless signal that is transmitted in a direction of a receiving device. A beam may include a directional signal, a direction associated with a signal, a set of directional resources associated with a signal (e.g., angle of arrival, horizontal direction, vertical direction), and/or a set of parameters that indicate one or more aspects of a directional signal, a direction associated with a signal, and/or a set of directional resources associated with a signal.

As indicated above, antenna elements and/or sub-elements may be used to generate beams. For example, antenna elements may be individually selected or deselected for transmission of a signal (or signals) by controlling an amplitude of one or more corresponding amplifiers. Beamforming includes generation of a beam using multiple signals on different antenna elements, where one or more, or all, of the multiple signals are shifted in phase relative to each other. The formed beam may carry physical or higher layer reference signals or information. As each signal of the multiple signals is radiated from a respective antenna element, the radiated signals interact, interfere (constructive and destructive interference), and amplify each other to form a resulting beam. The shape (such as the amplitude, width, and/or presence of side lobes) and the direction (such as an angle of the beam relative to a surface of an antenna array) can be dynamically controlled by modifying the phase shifts or phase offsets of the multiple signals relative to each other.

Beamforming may be used for communications between a UE and a base station, such as for millimeter wave communications and/or the like. In such a case, the base station may provide the UE with a configuration of transmission configuration indicator (TCI) states that respectively indicate beams that may be used by the UE, such as for receiving a physical downlink shared channel (PDSCH). The base station may indicate an activated TCI state to the UE, which the UE may use to select a beam for receiving the PDSCH.

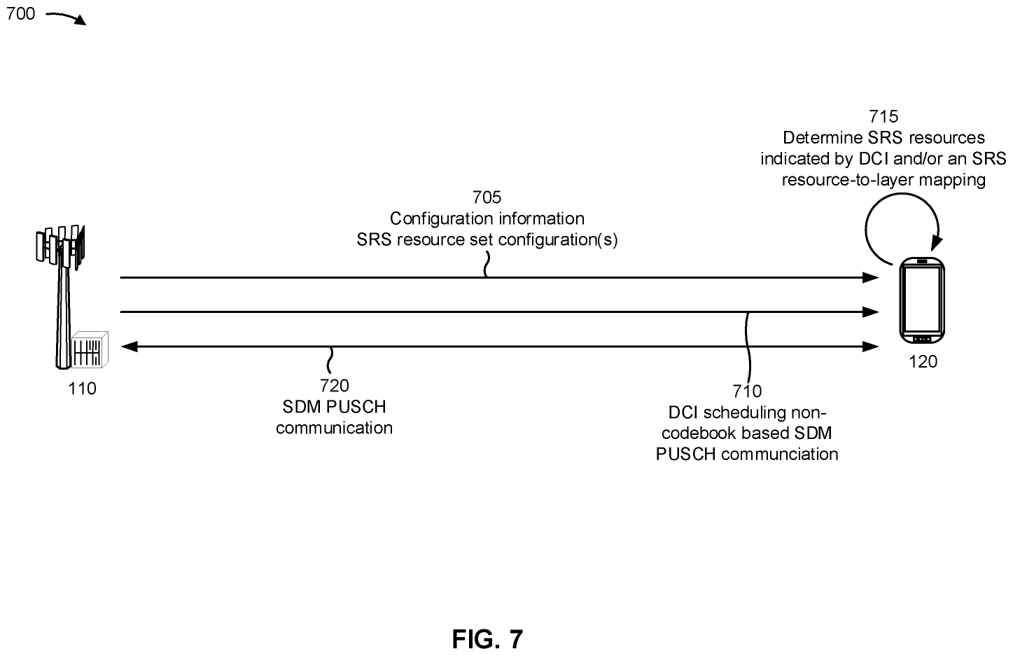

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the base station 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 7-12).

At the base station 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The base station 110 may include a communication unit 244 and may communicate with the network controller 130 via the communication unit 244. The base station 110 may include a scheduler 246 to schedule one or more UEs 120 for downlink and/or uplink communications. In some examples, the modem 232 of the base station 110 may include a modulator and a demodulator. In some examples, the base station 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 7-12).

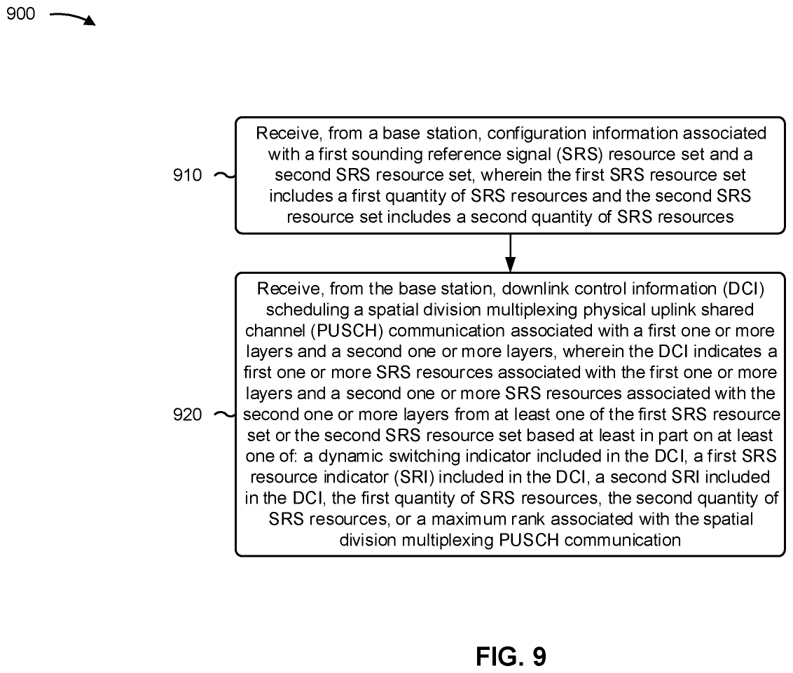

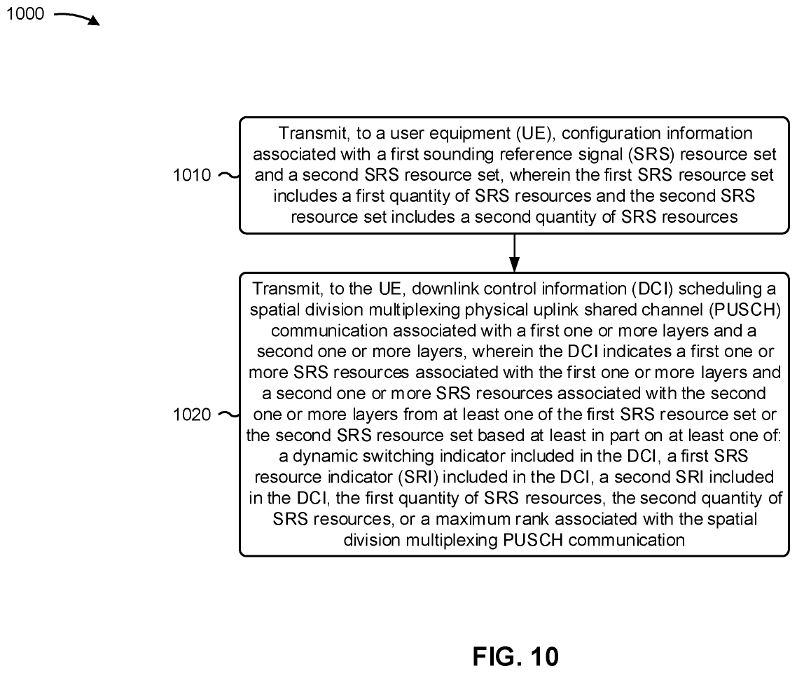

The controller/processor 240 of the base station 110, the controller/processor 280 of the UE 120, and/or any other component(s) of FIG. 2 may perform one or more techniques associated with SRI signaling for spatial division multiplexing (SDM) communications, as described in more detail elsewhere herein. For example, the controller/processor 240 of the base station 110, the controller/processor 280 of the UE 120, and/or any other component(s) of FIG. 2 may perform or direct operations of, for example, process 900 of FIG. 9, process 1000 of FIG. 10, and/or other processes as described herein. The memory 242 and the memory 282 may store data and program codes for the base station 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the base station 110 and/or the UE 120, may cause the one or more processors, the UE 120, and/or the base station 110 to perform or direct operations of, for example, process 900 of FIG. 9, process 1000 of FIG. 10, and/or other processes as described herein. In some examples, executing instructions may include running the instructions, converting the instructions, compiling the instructions, and/or interpreting the instructions, among other examples.

In some aspects, the UE 120 includes means for receiving, from a base station, configuration information associated with a first SRS resource set and a second SRS resource set, wherein the first SRS resource set includes a first quantity of SRS resources and the second SRS resource set includes a second quantity of SRS resources (e.g., using antenna 252, DEMOD 254, MIMO detector 256, receive processor 258, controller/processor 280, and/or memory 282); and/or means for receiving, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication (e.g., using antenna 252, DEMOD 254, MIMO detector 256, receive processor 258, controller/processor 280, and/or memory 282). The means for the UE 120 to perform operations described herein may include, for example, one or more of communication manager 140, antenna 252, modem 254, MIMO detector 256, receive processor 258, transmit processor 264, TX MIMO processor 266, controller/processor 280, or memory 282.

In some aspects, the base station includes means for transmitting, to a UE, configuration information associated with a first SRS resource set and a second SRS resource set, wherein the first SRS resource set includes a first quantity of SRS resources and the second SRS resource set includes a second quantity of SRS resources (e.g., using controller/processor 240, transmit processor 220, TX MIMO processor 230, MOD 232, antenna 234, and/or memory 242); and/or means for transmitting, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication (e.g., using controller/processor 240, transmit processor 220, TX MIMO processor 230, MOD 232, antenna 234, and/or memory 242). The means for the base station to perform operations described herein may include, for example, one or more of communication manager 150, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

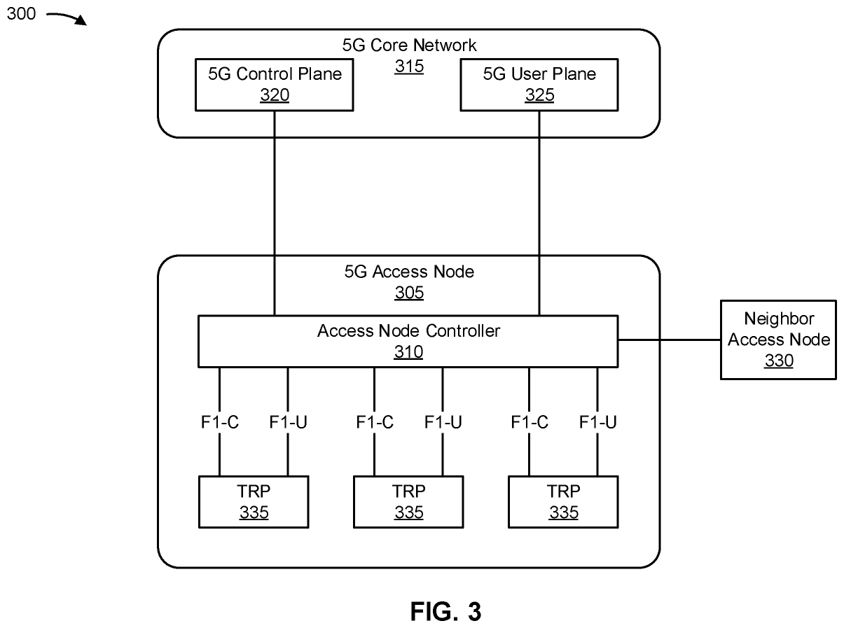

FIG. 3 illustrates an example logical architecture of a distributed radio access network (RAN) 300, in accordance with the present disclosure.

A 5G access node 305 may include an access node controller 310. The access node controller 310 may be a central unit (CU) of the distributed RAN 300. In some examples, a backhaul interface to a 5G core network 315 may terminate at the access node controller 310. The 5G core network 315 may include a 5G control plane component 320 and a 5G user plane component 325 (e.g., a 5G gateway), and the backhaul interface for one or both of the 5G control plane and the 5G user plane may terminate at the access node controller 310. Additionally, or alternatively, a backhaul interface to one or more neighbor access nodes 330 (e.g., another 5G access node 305 and/or an LTE access node) may terminate at the access node controller 310.

The access node controller 310 may include and/or may communicate with one or more TRPs 335 (e.g., via an F1 Control (F1-C) interface and/or an F1 User (F1-U) interface). A TRP 335 may be a distributed unit (DU) of the distributed RAN 300. In some examples, a TRP 335 may correspond to a base station 110 described above in connection with FIG. 1. For example, different TRPs 335 may be included in different base stations 110. Additionally, or alternatively, multiple TRPs 335 may be included in a single base station 110. In some examples, a base station 110 may include a CU (e.g., access node controller 310) and/or one or more DUs (e.g., one or more TRPs 335). In some cases, a TRP 335 may be referred to as a cell, a panel, an antenna array, or an array.

A TRP 335 may be connected to a single access node controller 310 or to multiple access node controllers 310. In some examples, a dynamic configuration of split logical functions may be present within the architecture of distributed RAN 300. For example, a packet data convergence protocol (PDCP) layer, a radio link control (RLC) layer, and/or a medium access control (MAC) layer may be configured to terminate at the access node controller 310 or at a TRP 335.

In some examples, multiple TRPs 335 may transmit communications (e.g., the same communication or different communications) in the same transmission time interval (TTI) (e.g., a slot, a mini-slot, a subframe, or a symbol) or different TTIs using different quasi co-location (QCL) relationships (e.g., different spatial parameters, different TCI states, different precoding parameters, and/or different beamforming parameters). In some examples, a TCI state may be used to indicate one or more QCL relationships. A TRP 335 may be configured to individually (e.g., using dynamic selection) or jointly (e.g., using joint transmission with one or more other TRPs 335) serve traffic to a UE 120.

As indicated above, FIG. 3 is provided as an example. Other examples may differ from what was described with regard to FIG. 3.

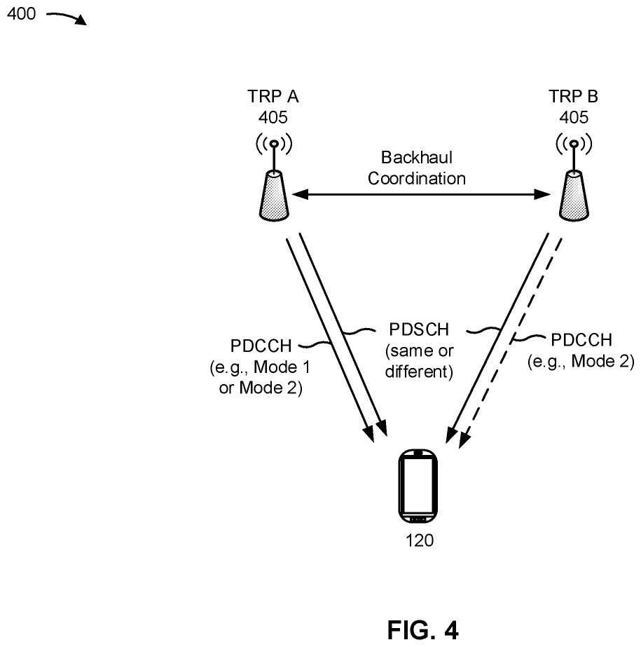

FIG. 4 is a diagram illustrating an example 400 of multi-TRP communication, in accordance with the present disclosure. Multi-TRP communication may sometimes referred to as multi-panel communication. As shown in FIG. 4, multiple TRPs 405 may communicate with the same UE 120. A TRP 405 may correspond to a TRP 335 described above in connection with FIG. 3.

The multiple TRPs 405 (shown as TRP A and TRP B) may communicate with the same UE 120 in a coordinated manner (e.g., using coordinated multipoint transmissions) to improve reliability and/or increase throughput. The TRPs 405 may coordinate such communications via an interface between the TRPs 405 (e.g., a backhaul interface and/or an access node controller 310). The interface may have a smaller delay and/or higher capacity when the TRPs 405 are co-located at the same base station 110 (e.g., when the TRPs 405 are different antenna arrays or panels of the same base station 110), and may have a larger delay and/or lower capacity (as compared to co-location) when the TRPs 405 are located at different base stations 110. The different TRPs 405 may communicate with the UE 120 using different QCL relationships (e.g., different TCI states), different DMRS ports, and/or different layers (e.g., of a multi-layer communication).

In a first multi-TRP transmission mode (e.g., Mode 1), a single physical downlink control channel (PDCCH) may be used to schedule downlink data communications for a single PDSCH. In this case, multiple TRPs 405 (e.g., TRP A and TRP B) may transmit communications to the UE 120 on the same PDSCH. For example, a communication may be transmitted using a single codeword with different spatial layers for different TRPs 405 (e.g., where one codeword maps to a first set of layers transmitted by a first TRP 405 and maps to a second set of layers transmitted by a second TRP 405). As another example, a communication may be transmitted using multiple codewords, where different codewords are transmitted by different TRPs 405 (e.g., using different sets of layers). In either case, different TRPs 405 may use different QCL relationships (e.g., different TCI states) for different DMRS ports corresponding to different layers. For example, a first TRP 405 may use a first QCL relationship or a first TCI state for a first set of DMRS ports corresponding to a first set of layers, and a second TRP 405 may use a second (different) QCL relationship or a second (different) TCI state for a second (different) set of DMRS ports corresponding to a second (different) set of layers. In some examples, a TCI state in DCI (e.g., transmitted on the PDCCH, such as DCI format 1_0 or DCI format 1_1) may indicate the first QCL relationship (e.g., by indicating a first TCI state) and the second QCL relationship (e.g., by indicating a second TCI state). The first TCI state and the second TCI states may be indicated using a TCI field in the DCI. In general, the TCI field can indicate a single TCI state (for single-TRP transmission) or multiple TCI states (for multi-TRP transmission as discussed here) in this multi-TRP transmission mode (e.g., Mode 1).

In a second multi-TRP transmission mode (e.g., Mode 2), multiple PDCCHs may be used to schedule downlink data communications for multiple corresponding PDSCHs (e.g., one PDCCH for each PDSCH). In this case, a first PDCCH may schedule a first codeword to be transmitted by a first TRP 405, and a second PDCCH may schedule a second codeword to be transmitted by a second TRP 405. Furthermore, first DCI (e.g., transmitted by the first TRP 405) may schedule a first PDSCH communication associated with a first set of DMRS ports with a first QCL relationship (e.g., indicated by a first TCI state) for the first TRP 405, and second DCI (e.g., transmitted by the second TRP 405) may schedule a second PDSCH communication associated with a second set of DMRS ports with a second QCL relationship (e.g., indicated by a second TCI state) for the second TRP 405. In this case, DCI (e.g., having DCI format 1_0 or DCI format 1_1) may indicate a corresponding TCI state for a TRP 405 corresponding to the DCI. The TCI field of a DCI indicates the corresponding TCI state (e.g., the TCI field of the first DCI indicates the first TCI state and the TCI field of the second DCI indicates the second TCI state).

As indicated above, FIG. 4 is provided as an example. Other examples may differ from what is described with respect to FIG. 4.

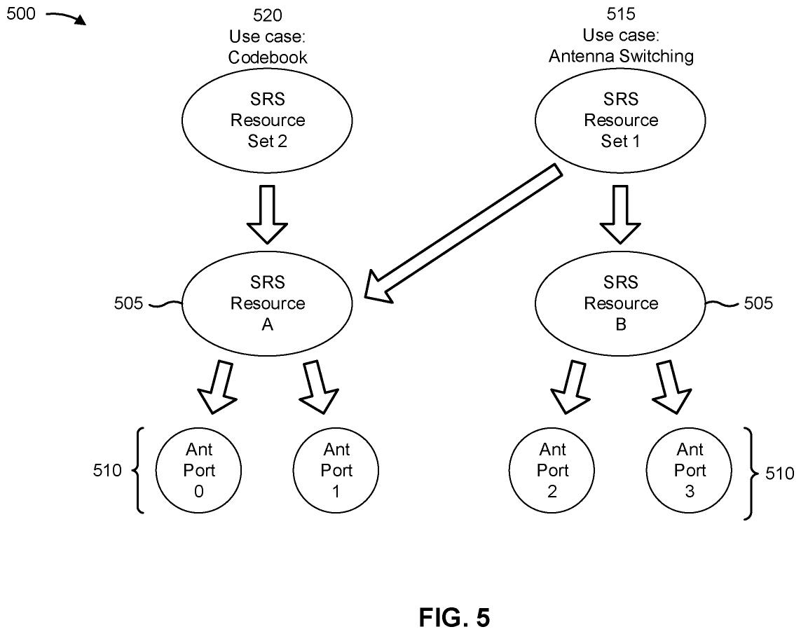

FIG. 5 is a diagram illustrating an example 500 of SRS resource sets, in accordance with the present disclosure.

A base station 110 may configure a UE 120 with one or more SRS resource sets to allocate resources for SRS transmissions by the UE 120. For example, a configuration for SRS resource sets may be indicated in a radio resource control (RRC) message (e.g., an RRC configuration message or an RRC reconfiguration message). As shown by reference number 505, an SRS resource set may include one or more resources (e.g., shown as SRS resources), which may include time resources and/or frequency resources (e.g., a slot, a symbol, a resource block, and/or a periodicity for the time resources). For example, in some cases, an SRS resource set may include up to 16 SRS resources.

As shown by reference number 510, an SRS resource may include one or more antenna ports on which an SRS is to be transmitted (e.g., in a time-frequency resource). Thus, a configuration for an SRS resource set may indicate one or more time-frequency resources in which an SRS is to be transmitted and may indicate one or more antenna ports on which the SRS is to be transmitted in those time-frequency resources. In some examples, the configuration for an SRS resource set may indicate a use case (e.g., in an SRS-SetUse information element) for the SRS resource set. For example, an SRS resource set may have a use case of antenna switching, codebook, non-codebook, or beam management. The “use case” of an SRS resource set may also be referred to as a “usage” of the SRS resource set.

In some examples, a configured SRS resource set and/or a configured SRS resource may be indicated (e.g., by the base station 110) via an SRI. For example, DCI scheduling a transmission of an SRS using a configured SRS resource may include an SRI (e.g., in an SRI field of the DCI) to indicate the SRS resource and/or the SRS resource set to be used by the UE 120 to transmit the SRS.

An antenna switching SRS resource set may be used to indicate downlink channel state information (CSI) with reciprocity between an uplink and downlink channel. For example, when there is reciprocity between an uplink channel and a downlink channel, a base station 110 may use an antenna switching SRS (e.g., an SRS transmitted using a resource of an antenna switching SRS resource set) to acquire downlink CSI (e.g., to determine a downlink precoder to be used to communicate with the UE 120).

A codebook SRS resource set may be used to indicate uplink CSI when a base station 110 indicates an uplink precoder to the UE 120. For example, when the base station 110 is configured to indicate an uplink precoder to the UE 120 (e.g., using a precoder codebook), the base station 110 may use a codebook SRS (e.g., an SRS transmitted using a resource of a codebook SRS resource set) to acquire uplink CSI (e.g., to determine an uplink precoder to be indicated to the UE 120 and used by the UE 120 to communicate with the base station 110). In some examples, virtual ports (e.g., a combination of two or more antenna ports) with a maximum transmit power may be supported at least for a codebook SRS.

In some examples, the UE 120 may be configured with one SRS resource set (e.g., only one) with a usage set to codebook (e.g., the UE 120 may only be configured with one codebook SRS resource set). In some examples, a codebook SRS resource set may include up to 4 SRS resources (e.g., a maximum of 4 SRS resources may be configured for the codebook SRS resource set). Each SRS resource (e.g., included in the codebook SRS resource set) may be configured with a quantity of antenna ports (e.g., in a nrofSRS-Ports information element of an RRC configuration). An SRI in DCI scheduling a transmission of a codebook SRS may indicate one (e.g., only one) SRS resource in a codebook SRS resource set. A quantity of ports configured for the indicated SRS resource (e.g., in the nrofSRS-Ports information element) may identify a quantity of antenna ports for the PUSCH to be used to transmit the communication scheduled by the DCI. The UE 120 may transmit the communication scheduled by the DCI (e.g., on the PUSCH) using the same spatial domain filter (e.g., the same uplink beam) as the indicated SRS resource (e.g., the SRS resource indicated by the SRI included in the DCI). A quantity of layers (e.g., rank) and/or a transmit precoder matrix indicator (TPMI) (e.g., precoder) to be used by the UE 120 to transmit the communication scheduled by the DCI (e.g., on the PUSCH) may be indicated via separate fields in the DCI (e.g., in a precoding information field and/or a quantity of layers field). As used herein, “layer” may refer to a data stream. In some cases, “layer” may be used interchangeably with “MIMO layer.” “Rank” may refer to a quantity of layers associated with a given communication. A size (e.g., a quantity of bits) associated with the SRI may be based at least in part on a quantity of SRS resources included in the codebook SRS resource set.

A non-codebook SRS resource set may be used to indicate uplink CSI when the UE 120 selects an uplink precoder (e.g., instead of the base station 110 indicating an uplink precoder to be used by the UE 120). For example, when the UE 120 is configured to select an uplink precoder, the base station 110 may use a non-codebook SRS (e.g., an SRS transmitted using a resource of a non-codebook SRS resource set) to acquire uplink CSI. In this case, the non-codebook SRS may be precoded using a precoder selected by the UE 120 (e.g., which may be indicated to the base station 110). A beam management SRS resource set may be used for indicating CSI for millimeter wave communications.

In some examples, the UE 120 may be configured with one SRS resource set (e.g., only one SRS resource set) with a usage set to non-codebook (e.g., the UE 120 may be configured with only one non-codebook SRS resource set). In some examples, a non-codebook SRS resource set may include up to 4 SRS resources (e.g., a maximum of 4 SRS resources may be configured for the non-codebook SRS resource set). In some examples, each SRS resource included in the non-codebook SRS resource set may be associated with one (e.g., a single) antenna port (e.g., a single SRS port). A non-codebook SRS resource set also may be used to facilitate non-codebook-based PUSCH transmission. For example, an SRI in a DCI may indicate one or more SRS resources from a non-codebook based PUSCH transmission (e.g., a single SRI may include one or more SRS resources). A quantity of SRS resources indicated by the SRI may indicate a quantity of layers (e.g., a rank) associated with the non-codebook based transmission scheduled by the DCI (e.g., to be transmitted via the PUSCH). The communication scheduled by the DCI may use the same precoder and the same spatial domain filter (e.g., the same uplink beam) as the SRS resource(s) indicated by the SRI.

A size (e.g., a quantity of bits) associated with the SRI may be based at least in part on a quantity of SRS resources included in the non-codebook SRS resource set. For example, a size (e.g., a quantity of bits) associated with the SRI may be based at least in part on a maximum rank associated with the PUSCH and the quantity of SRS resources included in the non-codebook SRS resource set. The maximum rank for the PUSCH may be configured (e.g., in a MIMO configuration, such as in the higher layer parameter maxMIMO-Layers of a PUSCH configuration) or may be based at least in part on a quantity of layers supported by the UE 120 for the PUSCH (e.g., for non-codebook based operations). The size of the SRI may be defined, or otherwise fixed, by a wireless communication standard, such as the 3GPP (e.g., in 3GPP Technical Specification 38.212). For example, a size of an SRI (e.g., a quantity of bits associated with the SRI) may be defined according to the equation

$$⌈ {log}_{2} ( {\sum }_{k = 1}^{min \{ {L}_{max} , {N}_{SRS} \}} ( \begin{matrix}{N}_{SRS} \\ k\end{matrix} ) ) ⌉ ,$$

where Lₘₐₓ is the maximum rank associated with the PUSCH and N_{SRS} is the quantity of SRS resources included in the non-codebook SRS resource set. For example, the equation described above may be used to identify a size of the SRI when higher layer parameter indicates that a transmission is a non-codebook transmission (e.g., in a txConfig higher layer parameter). In other words, the equation described above may be used to identify a size of the SRI for non-codebook based PUSCH transmissions.

An SRS resource can be configured as periodic, semi-persistent (sometimes referred to as semi-persistent scheduling (SPS)), or aperiodic. A periodic SRS resource may be configured via a configuration message that indicates a periodicity of the SRS resource (e.g., a slot-level periodicity, where the SRS resources occurs every Y slots) and a slot offset. In some cases, a periodic SRS resource may always be activated, and may not be dynamically activated or deactivated. A semi-persistent SRS resource may also be configured via a configuration message that indicates a periodicity and a slot offset for the semi-persistent SRS resource, and may be dynamically activated and deactivated (e.g., using DCI or a MAC control element (CE) (MAC-CE)). An aperiodic SRS resource may be triggered dynamically, such as via DCI (e.g., UE-specific DCI or group common DCI) or a MAC-CE.

In some examples, the UE 120 may be configured with a mapping between SRS ports (e.g., antenna ports) and corresponding SRS resources. The UE 120 may transmit an SRS on a particular SRS resource using an SRS port indicated in the configuration. In some examples, an SRS resource may span N adjacent symbols within a slot (e.g., where N equals 1, 2, or 4). The UE 120 may be configured with X SRS ports (e.g., where X≤4). In some examples, each of the X SRS ports may mapped to a corresponding symbol of the SRS resource and used for transmission of an SRS in that symbol.

As shown in FIG. 5, in some examples, different SRS resource sets indicated to the UE 120 (e.g., having different use cases) may overlap (e.g., in time and/or in frequency, such as in the same slot). For example, as shown by reference number 515, a first SRS resource set (e.g., shown as SRS Resource Set 1) is shown as having an antenna switching use case. As shown, this example antenna switching SRS resource set includes a first SRS resource (shown as SRS Resource A) and a second SRS resource (shown as SRS Resource B). Thus, antenna switching SRS may be transmitted in SRS Resource A (e.g., a first time-frequency resource) using antenna port 0 and antenna port 1 and may be transmitted in SRS Resource B (e.g., a second time-frequency resource) using antenna port 2 and antenna port 3.

As shown by reference number 520, a second SRS resource set (e.g., shown as SRS Resource Set 2) may be a codebook use case. As shown, this example codebook SRS resource set includes only the first SRS resource (shown as SRS Resource A). Thus, codebook SRSs may be transmitted in SRS Resource A (e.g., the first time-frequency resource) using antenna port 0 and antenna port 1. In this case, the UE 120 may not transmit codebook SRSs in SRS Resource B (e.g., the second time-frequency resource) using antenna port 2 and antenna port 3.

As indicated above, FIG. 5 is provided as an example. Other examples may differ from what is described with regard to FIG. 5.

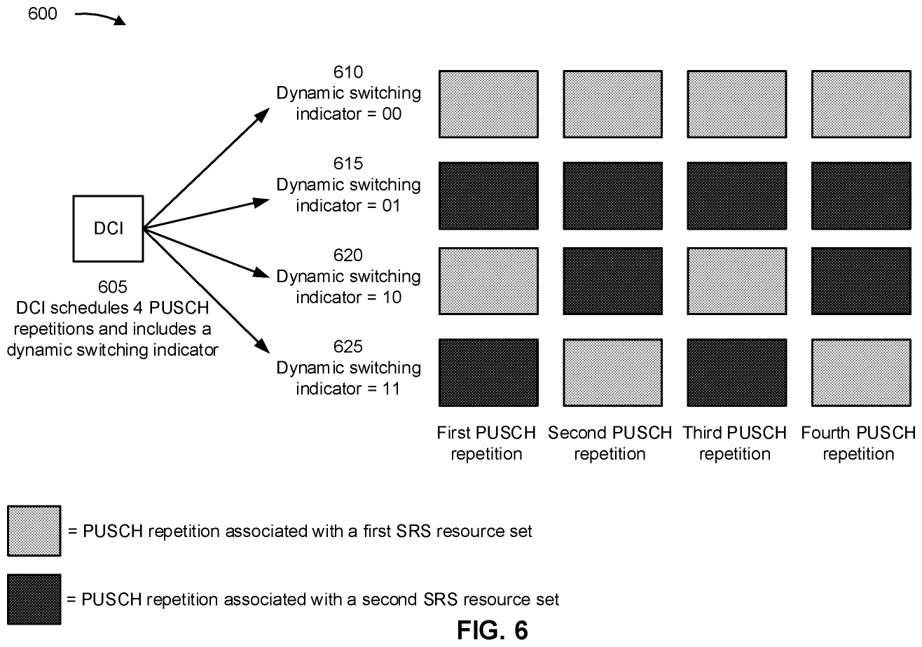

FIG. 6 is a diagram illustrating an example 600 of dynamic switching between single-TRP (sTRP) communications and multi-TRP (mTRP) communications, in accordance with the present disclosure. For example, in some cases, a UE may communicate with two TRPs (e.g., in a similar manner as described in connection with FIG. 4). Communication with more than one TRP may be referred to as mTRP communication, whereas communication with one TRP may be referred to sTRP communication. In mTRP, the two sets of PUSCH repetitions can correspond to two SRS resource sets. For example, a DCI transmission can indicate two beams and two sets of power control parameters using two corresponding SRI fields. For codebook-based PUSCH, the DCI transmission also indicates two TPMIs.

PUSCH repetitions can be transmitted using time division multiplexing (TDM), in which the PUSCH repetitions correspond to different transmission parameters (beam/spatial relation, power control, precoding). In some cases, PUSCH repetitions that are scheduled by a single DCI transmission can belong to two sets, where each set has its own transmission parameters.

In some cases, a UE may be configured to dynamically switch between sTRP communication and mTRP communication. For dynamic switching between sTRP and mTRP (e.g., dynamic switching between one set of transmission parameters for PUSCH repetitions and two sets of transmission parameters for PUSCH repetitions), a wireless communication standard (e.g., the 3GPP) introduced a new field in a DCI format. The new field, which may be referred to as a dynamic switching field or a dynamic switching indicator, may be 2 bits and may indicate that the UE is to use a first set of parameters only (e.g., to transmit to a first TRP, TRP1); use a second set of parameters only (e.g., to transmit to a second TRP, TRP2); use both sets of parameters for two sets of repetitions with a first order (TRP1, TRP2); or use both sets of parameters for two sets of repetitions with a second order (TRP2, TRP1), which may be referred to as a reversed order. In the case of TDM communications, the rank and antenna ports are the same across all the repetitions.

For example, as shown in FIG. 6 and by reference number 605, a DCI may schedule 4 repetitions of a PUSCH transmission (e.g., may schedule 4 PUSCH repetitions). The DCI may indicate a first SRS resource set (e.g., via a first SRI included in the DCI) and a second SRS resource set (e.g., via a second SRI included in the DCI). As described in more detail elsewhere herein, an SRS resource and/or SRS resource set (e.g., indicated via an SRI) may indicate a beam and/or a set of transmission parameters to be used for the PUSCH transmission (e.g., the PUSCH repetition(s)) scheduled by the DCI. The DCI may also include the dynamic switching indicator (e.g., may include a dynamic switching field). A value (e.g., a codepoint) of the dynamic switching indicator may indicate whether the uplink transmission scheduled by the DCI is an sTRP communication (e.g., as shown by reference number 610, where the value of the dynamic switching indicator is “00,” and by reference number 615, where the value of the dynamic switching indicator is “01”) or is an mTRP communication (e.g., as shown by reference number 620, where the value of the dynamic switching indicator is “10,” and by reference number 625, where the value of the dynamic switching indicator is “11”). Additionally, the value (e.g., a codepoint) of the dynamic switching indicator may indicate which SRS resource set (e.g., in the case of sTRP communications) is to be associated with the uplink transmission scheduled by the DCI. In the case of mTRP communications, the value (e.g., a codepoint) of the dynamic switching indicator may indicate an order or pattern (e.g., of the multiple SRS resource sets) to be used by the UE to transmit PUSCH repetitions scheduled by the DCI.

For example, as shown by reference number 610, a first value or codepoint (e.g., “00”) of the dynamic switching indicator may indicate that the PUSCH repetitions scheduled by the DCI are to be sTRP communications. Additionally, the first value or codepoint (e.g., “00”) may indicate that the PUSCH repetitions are to be associated with the first SRS resource set (e.g., indicated by the first SRI included in the DCI). Therefore, the UE may transmit the PUSCH repetitions using a beam and/or a set of transmission parameters indicated by the first SRS resource set (e.g., indicated by an SRS resource included in the first SRS resource set).

As another example, and as shown by reference number 615, a second value or codepoint (e.g., “01”) of the dynamic switching indicator may indicate that the PUSCH repetitions scheduled by the DCI are to be sTRP communications. Additionally, the second value or codepoint (e.g., “01”) may indicate that the PUSCH repetitions are to be associated with the second SRS resource set (e.g., indicated by the second SRI included in the DCI). Therefore, the UE may transmit the PUSCH repetitions using a beam and/or a set of transmission parameters indicated by the second SRS resource set (e.g., indicated by an SRS resource included in the second SRS resource set).

As another example, and as shown by reference number 620, a third value or codepoint (e.g., “10”) of the dynamic switching indicator may indicate that the PUSCH repetitions scheduled by the DCI are to be mTRP communications. For example, the third value or codepoint (e.g., “10”) may indicate that both the first SRS resource set and the second SRS resource set are to be used to identify beams and/or transmission parameters for the PUSCH repetitions. Additionally, the third value or codepoint (e.g., “10”) may indicate a first pattern associated with the PUSCH repetitions. For example, the first pattern may indicate that the first PUSCH repetition and the third PUSCH repetition are to be associated with the first SRS resource set and that the second PUSCH repetition and the fourth PUSCH repetition are to be associated with the second SRS resource set. The UE may transmit the first PUSCH repetition and the third PUSCH repetition using a first beam and/or a first set of transmission parameters indicated by the first SRS resource set. The UE may transmit the second PUSCH repetition and the fourth PUSCH repetition using a second beam and/or a second set of transmission parameters indicated by the second SRS resource set. For example, the UE may transmit the first PUSCH repetition and the third PUSCH repetition to a first TRP and may transmit the second PUSCH repetition and the fourth PUSCH repetition to a second TRP. The first pattern shown in FIG. 6 is provided as an example and other patterns are also possible, such as a sequential pattern in which the first PUSCH repetition and the second PUSCH repletion are associated with the first SRS resource set and the third PUSCH repetition and the fourth PUSCH repetition are associated with the second SRS resource set.

As yet another example, and as shown by reference number 625, a fourth value or codepoint (e.g., “11”) of the dynamic switching indicator may indicate that the PUSCH repetitions scheduled by the DCI are to be mTRP communications. For example, the fourth value or codepoint (e.g., “11”) may indicate that both the first SRS resource set and the second SRS resource set are to be used to identify beams and/or transmission parameters for the PUSCH repetitions. Additionally, the fourth value or codepoint (e.g., “11”) may indicate a second pattern associated with the PUSCH repetitions. For example, the second pattern may indicate that the first PUSCH repetition and the third PUSCH repetition are to be associated with the second SRS resource set and that the second PUSCH repetition and the fourth PUSCH repetition are to be associated with the first SRS resource set. The UE may transmit the first PUSCH repetition and the third PUSCH repetition using the second beam and/or the second set of transmission parameters indicated by the second SRS resource set. The UE may transmit the second PUSCH repetition and the fourth PUSCH repetition using the first beam and/or the first set of transmission parameters indicated by the first SRS resource set. For example, the UE may transmit the first PUSCH repetition and the third PUSCH repetition to the second TRP and may transmit the second PUSCH repetition and the fourth PUSCH repetition to the first TRP. The second pattern shown in FIG. 6 is provided as an example and other patterns are also possible, such as a sequential pattern in which the first PUSCH repetition and the second PUSCH repletion are associated with the second SRS resource set and the third PUSCH repetition and the fourth PUSCH repetition are associated with the first SRS resource set.

In this way, the UE may be scheduled to dynamically switch between sTRP communication and mTRP communication. Additionally, a single DCI may schedule the UE to transmit PUSCH repetitions in a TDM manner, in which the PUSCH repetitions correspond to different transmission parameters (beam/spatial relation, power control, precoding).

In the case of SDM for PUSCH, different sets of layers have different transmission parameters (e.g., different beams, different sets of power control parameters, and/or different TPMIs, among other examples). For example, a first set of layers may be associated with a first SRS resource set, a first beam, and/or a first set of transmission parameters, among other examples, and a second set of layers may be associated with a second SRS resource set, a second beam, and/or a second set of transmission parameters, among other examples. The first set of layers may be associated with the first SRS resource set, and the second set of layers may be associated with the second SRS resource set. In some cases, a number of rank combinations can be supported such as, for example, rank combinations 1+1 (e.g., where the first set of layers includes a single layer and the second set of layers includes a single layer), 1+2 (e.g., where the first set of layers includes a single layer and the second set of layers includes two layers), 2+1 (e.g., where the first set of layers includes two layers and the second set of layers includes a single layer), 2+2 (e.g., where the first set of layers includes two layers and the second set of layers includes two layers), 1+3 (e.g., where the first set of layers includes a single layer and the second set of layers includes three layers), and/or 3+1 (e.g., where the first set of layers includes three layers and the second set of layers includes a single layer), among other examples.

However, wireless communication standards do not specify a technique for determining which SRS resource sets are to be associated with the first set of layers and which SRS resources sets are to be associated with the second set of layers for an SDM PUSCH transmission. For example, when DCI includes two SRIs, the two SRIs may indicate SRS resources from a single SRS resource set for the first set of layers and the second set of layers (e.g., for sTRP communications) or may indicate SRS resources from both SRS resource sets for the first set of layers and the second set of layers (e.g., for mTRP communications). However, without a rule specifying a mapping to layers to an SRS resource set, a UE's mapping may be unanticipated by a base station, resulting in missed communications and network inefficiencies. Additionally, wireless communication standards do not specify a technique for determining a size of SRI(s) included in DCI for non-codebook based SDM PUSCH transmissions. As described elsewhere herein, a size of an SRI for a non-codebook based PUSCH transmission may be based at least in part on a maximum rank and a quantity of SRS resources included in a non-codebook SRS resource set. However, different SRS resource sets may include different quantities of SRS resources. Without a rule specifying a design of the SRIs for SDM PUSCH transmissions (e.g., without specifying a size of the SRIs) different networks may use different sizes of SRIs (e.g., different networks may use a different quantity of bits for each SRI included in the DCI scheduling a non-codebook based PUSCH transmission), resulting in a UE being unable to receive and/or decode the SRIs in some cases, such as when the UE expects a different design of the SRIs than the design used by the network.

Some aspects of the techniques and apparatuses described herein may facilitate SRI signaling for associating SRS resource sets and/or SRS resources with different layers for SDM. For example, in some aspects, a UE may receive configuration information associated with a first SRS resource set and a second SRS resource set, where the first SRS resource set includes a first quantity of SRS resources and the second SRS resource set includes a second quantity of SRS resources. The UE may receive DCI scheduling an SDM PUSCH communication associated with a first one or more layers and a second one or more layers. The DCI may indicate a first one or more SRS resources associated with the first one or more layers and a second one or more SRS resources associated with the second one or more layers. The first one or more SRS resources and the second one or more SRS resources may be from the first SRS resource set and/or the second SRS resource set. The DCI may indicate the first one or more SRS resources and the second one or more SRS resources based at least in part on a dynamic switching indicator included in the DCI, a first SRI included in the DCI, a second SRI included in the DCI, the first quantity of SRS resources, the second quantity of SRS resources, and/or a maximum rank associated with the SDM PUSCH communication, among other examples. In this way, some aspects of the techniques described herein may facilitate mapping SRS resources and/or SRS resource sets to layers of an SDM PUSCH transmission via SRIs included in DCI and/or via a dynamic switching indicators included in the DCI, thereby improving efficiencies and, in this way, positively impacting network performance.

As indicated above, FIG. 6 is provided as an example. Other examples may differ from what is described with regard to FIG. 6.

FIG. 7 is a diagram illustrating an example 700 associated with SRI signaling for SDM communications, in accordance with the present disclosure. As shown in FIG. 7, a base station 110 and a UE 120 may communicate with one another in a wireless network, such as the wireless network 100.

As shown by reference number 705, the base station 110 may transmit, and the UE 120 may receive, configuration information. In some aspects, the UE 120 may receive configuration information from another device (e.g., from another base station or another UE). In some aspects, the UE 120 may receive the configuration information via RRC signaling and/or MAC signaling (e.g., MAC-CEs). In some aspects, the configuration information may include an indication of one or more configuration parameters (e.g., already known to the UE 120 and/or hardcoded on the UE 120) for selection by the UE 120 and/or explicit configuration information for the UE 120 to use to configure itself.

In some aspects, the configuration information may indicate an SRS configuration. For example, the configuration information may configure one or more SRS resource sets. For example, the configuration information may indicate one or more SRS-ResourceSet information elements (e.g., as defined, or otherwise fixed, by a wireless communication standard, such as the 3GPP). For example, the configuration information may configure a first SRS resource set and a second SRS resource set. The first SRS resource set and the second SRS resource set may be non-codebook SRS resource sets (e.g., may be associated with a non-codebook usage or use case). The first SRS resource set may include a first quantity of SRS resources (e.g., referred to herein as N1), and the second SRS resource set may include a second quantity of SRS resources (e.g., referred to herein as N2).

In some aspects, the configuration information may be associated with an SDM configuration. The SDM configuration may be associated with a PUSCH having a first set of layers (e.g., a first one or more layers) and a second set of layers (e.g., a second one or more layers). The first set of layers may include a first quantity of layers and the second set of layers may include a second quantity of layers.

In some aspects, the UE 120 may configure itself for communicating with the base station 110. In some aspects, the UE 120 may configure the UE 120 based at least in part on the configuration information. In some aspects, the UE 120 may be configured to perform one or more operations described herein.

In some aspects, the UE 120 may transmit, and the base station 110 may receive, an indication of a capability of the UE 120 to communicate (e.g., one or more of uplink transmissions or downlink transmissions) using the SRI signaling for SDM PUSCH communications as described herein. In some aspects, the UE 120 may transmit the indication via RRC signaling, one or more MAC-CEs, and/or a physical uplink control channel (PUCCH) message, among other examples.

As shown by reference number 710, the base station 110 may transmit, and the UE 120 may receive, DCI (e.g., a DCI transmission). The DCI may schedule a non-codebook based SDM PUSCH communication. The DCI may include a first SRI (e.g., a first SRI field) and may include a second SRI (e.g., a second SRI field). In some aspects, the DCI may indicate two beams and/or two sets of power control parameters for two sets of layers via the two SRIs included in the DCI. In other words, the DCI (e.g., via the first SRI and/or the second SRI) may indicate a first beam and/or a first set of power control parameters for a first set of layers (e.g., a first one or more layers) associated with a non-codebook based SDM PUSCH communication. Additionally, the DCI (e.g., via the first SRI and/or the second SRI) may indicate a second beam and/or a second set of power control parameters for a second set of layers (e.g., a second one or more layers) associated with a non-codebook based SDM PUSCH communication.

In some aspects, the DCI may indicate a first one or more SRS resources associated with the first set of layers (e.g., the first one or more layers) and a second one or more SRS resources associated with the second set of layers (e.g., the second one or more layers) from at least one of the first SRS resource set or the second SRS resource set. The DCI may indicate the first one or more SRS resources and the second one or more SRS resources from the first SRS resource set (e.g., the first non-codebook SRS resource set) and/or the second SRS resource set (e.g., the second non-codebook SRS resource set). In some aspects, the DCI may indicate the first one or more SRS resources and the second one or more SRS resources based at least in part on a dynamic switching indicator included in the DCI, the first SRI included in the DCI, the second SRI included in the DCI, the first quantity of SRS resources (e.g., N1), the second quantity of SRS resources (e.g., N2), and/or a maximum rank associated with the PUSCH (e.g., associated with the SDM communication scheduled by the DCI), among other examples.

For example, in some aspects, the two SRIs may jointly indicate SRS resources from a single SRS resource set (e.g., for sTRP SDM communications when SDM is configured). As used herein, “jointly indicate” may refer to both a first indicator (e.g., a value of the first indicator) and a second indicator (e.g., a value of the second indicator) being used to identify information. In some aspects, “jointly indicate” may refer to the first SRI and the second SRI being included in a joint field or the same field of the DCI. For example, the first SRI and the second SRI may jointly indicate one or more SRS resources from the first SRS resource set based at least in part on the dynamic switching indicator being associated with a first value. Alternatively, the first SRI and the second SRI may jointly indicate one or more SRS resources from the second SRS resource set based at least in part on the dynamic switching indicator being associated with a second value. For example, a dynamic switching indicator value (e.g., codepoint) of “00” may indicate that the first SRI and the second SRI jointly indicate one or more SRS resources from the first SRS resource set for the SDM communication, whereas a dynamic switching indicator value (e.g., codepoint) of “01” may indicate that the first SRI and the second SRI jointly indicate one or more SRS resources from the second SRS resource set for the SDM communication.

In some aspects, the quantity of the one or more SRS resources from the first SRS resource set (e.g., jointly indicated by the first SRI and the second SRI if the dynamic switching indicator indicates a value of “00”) is based at least in part on the first quantity of SRS resources (e.g., included in the first SRS resource set) and the maximum rank (e.g., of the PUSCH). For example, the quantity of SRS resources from the first SRS resources that are jointly indicated by the first SRI and the second SRI may be less than or equal to a minimum of the maximum rank and the first quantity of SRS resources (e.g., may be less than or equal to min (Lₘₐₓ, N₁)). Similarly, the quantity of the one or more SRS resources from the second SRS resource set (e.g., jointly indicated by the first SRI and the second SRI if the dynamic switching indicator indicates a value of “01”) is based at least in part on the second quantity of SRS resources (e.g., included in the second SRS resource set) and the maximum rank. For example, the quantity of SRS resources from the second SRS resources that are jointly indicated by the first SRI and the second SRI may be less than or equal to a minimum of the maximum rank and the second quantity of SRS resources (e.g., may be less than or equal to min (Lₘₐₓ, N₂)).

For sTRP communications (e.g., when SDM is configured), the first SRI and the second SRI may be associated with an aggregated size (e.g., a size that includes a size of the first SRI and a size of the second SRI). The aggregated size may be based at least in part on a first quantity of bits that is based at least in part on the first quantity of SRS resources (e.g., included in the first SRS resource set) and the maximum rank. For example, the aggregated size may be based at least in part on the maximum rank associated with the PUSCH and N1. For example, the first quantity of bits may be determined according to the equation:

$$⌈ {log}_{2} ( {\sum }_{k = 1}^{min \{ {L}_{max} , {N}_{1} \}} ( \begin{matrix}{N}_{1} \\ k\end{matrix} ) ) ⌉ .$$

Alternatively, the aggregated size may be based at least in part on a second quantity of bits that is based at least in part on the second quantity of SRS resources (e.g., included in the second SRS resource set) and the maximum rank. For example, the second quantity of bits may be determined according to the equation:

$$⌈ {log}_{2} ( {\sum }_{k = 1}^{min \{ {L}_{max} , {N}_{2} \}} ( \begin{matrix}{N}_{2} \\ k\end{matrix} ) ) ⌉ .$$

In some aspects, a quantity of bits needed for the SRIs for sTRP communications (e.g., when SDM is configured) may be a maximum of the first quantity of bits and the second quantity of bits. For example, a quantity of bits needed for the SRIs for sTRP communications (e.g., when SDM is configured) may be

$$max ( ⌈ {log}_{2} ( {\sum }_{k = 1}^{min \{ {L}_{max} , {N}_{1} \}} ( \begin{matrix}{N}_{1} \\ k\end{matrix} ) ) ⌉ , ⌈ {log}_{2} ( {\sum }_{k = 1}^{min \{ {L}_{max} , {N}_{2} \}} ( \begin{matrix}{N}_{2} \\ k\end{matrix} ) ) ⌉ ) .$$

In some aspects, the first SRS resource set may be associated with a first maximum rank, Lₘₐₓ¹, and the second SRS resource set may be associated with a second maximum rank, Lₘₐₓ². Additionally, the PUSCH may be associated with the maximum rank (e.g., Lₘₐₓ, described above). For sTRP communications (e.g., when SDM is configured), a maximum rank for an sTRP SDM communication may be a minimum of Lₘₐₓ and Lₘₐₓ¹+Lₘₐₓ². For example, the maximum rank may be min (Lₘₐₓ, Lₘₐₓ¹+Lₘₐₓ²). In such examples (e.g., where each SRS resource set is associated with a maximum rank), an aggregated size of the SRI fields may be based at least in part on a first quantity of bits that is based at least in part on the maximum rank Lₘₐₓ, the first maximum rank Lₘₐₓ¹, the second maximum rank Lₘₐₓ¹, and the first quantity of SRS resources N₁. For example, the first quantity of bits may be determined according to the equation:

$$⌈ {log}_{2} ( {\sum }_{k = 1}^{min \{ {L}_{max} , {L}_{max}^{1} + {L}_{max}^{2} , {N}_{1} \}} ( \begin{matrix}{N}_{1} \\ k\end{matrix} ) ) ⌉ .$$

Alternatively, the aggregated size of the SRI fields may be based at least in part on a first quantity of bits that is based at least in part on the maximum rank Lₘₐₓ, the first maximum rank Lₘₐₓ¹, the second maximum rank Lₘₐₓ², and the second quantity of SRS resources N₂. For example, the first quantity of bits may be determined according to the equation:

$$⌈ {log}_{2} ( {\sum }_{k = 1}^{min \{ {L}_{max} , {L}_{max}^{1} + {L}_{max}^{2} , {N}_{2} \}} ( \begin{matrix}{N}_{2} \\ k\end{matrix} ) ) ⌉ .$$

In some aspects, a quantity of bits needed for the SRIs for sTRP communications (e.g., when SDM is configured) may be a maximum of the first quantity of bits and the second quantity of bits. For example, a quantity of bits needed for the SRIs for sTRP communications (e.g., when SDM is configured) may be

$$max ( ⌈ {log}_{2} ( {\sum }_{k = 1}^{min \{ {L}_{max} , {L}_{max}^{1} + {L}_{max}^{2} , {N}_{1} \}} ( \begin{matrix}{N}_{1} \\ k\end{matrix} ) ) ⌉ , \\ ⌈ {log}_{2} ( {\sum }_{k = 1}^{min \{ {L}_{max} , {L}_{max}^{1} + {L}_{max}^{2} , {N}_{2} \}} ( \begin{matrix}{N}_{2} \\ k\end{matrix} ) ) ⌉ ) .$$

In examples where each SRS resource set is associated with a maximum rank, a maximum quantity associated with the one or more SRS resources from the first SRS resource set (e.g., jointly indicated by the first SRI and the second SRI if the dynamic switching indicator indicates a value of “00”) may be based at least in part on the maximum rank Lₘₐₓ, the first maximum rank Lₘₐₓ, the second maximum rank Lₘₐₓ², and the first quantity of SRS resources N₁. For example, for the dynamic switching codepoint “00,” the first SRI and the second SRI may jointly indicate up to the minimum of the maximum rank Lₘₐₓ, a combination of first maximum rank Lₘₐₓ¹ and the second maximum rank Lₘₐₓ² (e.g., Lₘₐₓ²+Lₘₐₓ²), and the first quantity of SRS resources N₁. For example, the quantity of resources from the first SRS resource set that are jointly indicated by the first SRI and the second SRI may be less than or equal to the min (Lₘₐₓ, Lₘₐₓ¹+Lₘₐₓ², N1). Similarly, a maximum quantity associated with the one or more SRS resources from the second SRS resource set (e.g., jointly indicated by the first SRI and the second SRI if the dynamic switching indicator indicates a value of “01”) may be based at least in part on the maximum rank Lₘₐₓ, the first maximum rank Lₘₐₓ¹, the second maximum rank Lₘₐₓ¹, and the second quantity of SRS resources N2. For example, for the dynamic switching codepoint “01,” the first SRI and the second SRI may jointly indicate up to the minimum of the maximum rank Lₘₐₓ, a combination of first maximum rank Linax and the second maximum rank L′inax (e.g., L′inax+L′max), and the second quantity of SRS resources N2. For example, the quantity of resources from the second SRS resource set that are jointly indicated by the first SRI and the second SRI may be less than or equal to the min (Lₘₐₓ, L′inax+Lₘₐₓ¹, N2).

For mTRP SDM communications, the DCI may indicate SRS resources from both the first SRS resource set and the second SRS resource set. In some aspects, a restriction may be defined that indicates SRS resources (or a quantity of SRS resources) (e.g., from the first SRS resource set and/or the second SRS resource set) that can be indicated by the DCI for mTRP SDM communications. The restriction may reduce a quantity of possible combinations of SRS resources that can be indicated by the DCI, thereby ensuring that a size of the SRIs included in the DCI is not exceedingly large. For example, the DCI may indicate up to a first quantity of indicated SRS resources (e.g., a first maximum quantity of SRS resources) from a first subset of SRS resources, of the first SRS resource set, and up to a second quantity of indicated SRS resources (e.g., a second maximum quantity of SRS resources) from a second subset of SRS resources of the second SRS resource set. The first subset and the second subset may be the SRS resources that are available for selection for mTRP SDM communications (e.g., according to the restriction described above).

In some aspects, a quantity of SRS resources included in the first subset of SRS resources is based at least in part on the first quantity of SRS resources (e.g., included in the first SRS resource set) and a portion of the maximum rank. In some aspects, the portion of the maximum rank, Lₘₐₓ, may be half of the maximum rank (e.g., Lₘₐₓ/2). For example, the quantity of SRS resources included in the first subset of SRS resources may be a minimum of the first quantity of SRS resources and the portion of the maximum rank (e.g., the quantity of SRS resources included in the first subset may be the min (N₁, Lₘₐₓ/2)) Similarly, a quantity of SRS resources included in the second subset of SRS resources is based at least in part on the second quantity of SRS resources (e.g., included in the second SRS resource set) and a portion of the maximum rank (e.g., which may be the same portion as the portion associated with the first subset or a different portion). In some aspects, the portion associated with the second subset may be based at least in part on the portion associated with the first subset. For example, if the portion associated with the first subset is P1, then the portion associated with the second subset may be equal to Lₘₐₓ−P1. For example, the portion associated with the second subset may be

$${L}_{max} - \frac{{L}_{max}}{2} .$$

In some aspects, the quantity of SRS resources included in the second subset of SRS resources may be a minimum of the second quantity of SRS resources and the portion of the maximum rank (e.g., the quantity of SRS resources included in the second subset may be the

$$min ( {N}_{2} , {L}_{max} - \frac{{L}_{max}}{2} ) ) .$$

In some aspects, the first subset of SRS resources may include the first Z SRS resources (e.g., according to an order of identifiers associated with the SRS resources included in the first SRS resource set) from the first SRS resource set, where Z is quantity of SRS resources included in the first subset of SRS resources. The second subset of SRS resources may include the first Q SRS resources (e.g., according to an order of identifiers associated with the SRS resources included in the second SRS resource set) from the second SRS resource set, where Q is quantity of SRS resources included in the second subset of SRS resources.

For mTRP SDM communications, the first SRI included in the DCI may indicate a first one or more indicated resources, from a first subset of SRS resources of the first SRS resource set, associated with the first set of layers. Similarly, the second SRI included in the DCI may indicate a second one or more indicated resources, from a second subset of SRS resources of the second SRS resource set, associated with the second set of layers. The first SRI may indicate up to (e.g., a maximum of) a first quantity of indicated SRS resources (e.g., a first maximum quantity of SRS resources) from the first subset of SRS resources. The first maximum quantity of SRS resources may be based at least in part on the first quantity of SRS resources (e.g., that are included in the first SRS resource set) and the portion of the maximum rank associated with the first subset. For example, the first maximum quantity of SRS resources may include up to (e.g., a maximum of) the min (N₁, Lₘₐₓ/2). Similarly, the second SRI may indicate up to (e.g., a maximum of) a second maximum quantity of SRS resources from the second subset of SRS resources. The second maximum quantity of SRS resources may be based at least in part on the second quantity of SRS resources (e.g., that are included in the second SRS resource set) and the portion of the maximum rank associated with the second subset. For example, the second maximum quantity of SRS resources may include up to (e.g., a maximum of) the

$$min ( {N}_{2} , {L}_{max} - \frac{{L}_{max}}{2} ) .$$

In some aspects, the configuration information may configure a third SRS resource set and a fourth SRS resource set (e.g., in addition to the first SRS resource set and the second SRS resource set). The third SRS resource set and the fourth SRS resource set may be non-codebook SRS resource sets. In some aspects, a first set of SRS resources included in the first SRS resource set may also be included in the third SRS resource set. For example, a quantity of SRS resources included in the first set of SRS resources (e.g., that are included in both the first SRS resource set and the third SRS resource set) may be based at least in part on the first quantity of SRS resources (e.g., included in the first SRS resource set and the portion of the maximum rank. For example, the first min (N₁, Lₘₐₓ/2) SRS resources included in the first SRS resource set and the third SRS resource set may be the same SRS resources. Additionally, a second set of SRS resources included in the second SRS resource set may also be included in the fourth SRS resource set. For example, a quantity of SRS resources included in the second set of SRS resources may be based at least in part on the second quantity of SRS resources (e.g., included in the second SRS resource set) and the portion of the maximum rank. For example, the first

$$min ( {N}_{2} , {L}_{max} - \frac{{L}_{max}}{2} )$$

SRS resources included in the second SRS resource set and the fourth SRS resource set may be the same SRS resources. In such examples, the first SRS resource set and the second SRS resource set may be used for mTRP communications and the third SRS resource set and the fourth SRS resource set may be used for sTRP communications (e.g., when SDM is configured).

In some aspects, SRS resources indicated for mTRP SDM communications may not be subject to the restriction described above. For example, the first SRI may indicate one or more SRS resource from the first SRS resource set (e.g., rather than from the first subset of SRS resources included in the first SRS resource set) and the second SRI may indicate one or more SRS resources from the second SRS resource set (e.g., rather than from the second subset of SRS resources included in the second SRS resource set). For example, the first SRI may indicate up to (e.g., a maximum of) min(N₁, Lₘₐₓ/2) SRS resources from the first SRS resource set (e.g., where the one or more SRS resources may include any SRS resources included in the first SRS resource set). Similarly, the second SRI may indicate up to (e.g., a maximum of)

$$min ( {N}_{2} , {L}_{max} - \frac{{L}_{max}}{2} )$$

SRS resources from the second SRS resource set (e.g., where the one or more SRS resources may include any SRS resources included in the second SRS resource set).

For mTRP SDM communications, in examples where the first SRS resource set is associated with the first maximum rank Lₘₐₓ¹ and the second SRS resource set is associated with the second maximum rank Lₘₐₓ², the first SRI may indicate one or more resources from the first SRS resource set and the second SRI may indicate one or more resources from the second SRS resource set. The one or more resources indicated by the first SRI (e.g., from the first SRS resource set) may be up to (e.g., a maximum of) a first quantity that is based at least in part on the first maximum rank Lₘₐₓ¹ and the first quantity of SRS resources (e.g., that are included in the first SRS resource set). For example, the one or more resources indicated by the first SRI (e.g., from the first SRS resource set) may be up to (e.g., a maximum of) min (N₁, Lₘₐₓ¹). The one or more resources indicated by the second SRI (e.g., from the second SRS resource set) may be up to (e.g., a maximum of) a second quantity that is based at least in part on the second maximum rank Lₘₐₓ² and the second quantity of SRS resources (e.g., that are included in the second SRS resource set). For example, the one or more resources indicated by the second SRI (e.g., from the second SRS resource set) may be up to (e.g., a maximum of) min (N₂, Lₘₐₓ²).

For mTRP SDM communications, the dynamic switching indicator may indicate values of “10” or “11.” The different values (e.g., different codepoints) may indicate different patterns for the mTRP SDM communications, however the association between SRIs and SRS resources may be the same for dynamic switching indicator codepoints associated with mTRP SDM communications (e.g., the association between SRIs and SRS resource sets may be the same for dynamic switching codepoints “10” and “11”).

Overall (e.g., for both mTRP and sTRP SDM communications) the first SRI and the second SRI are associated with an aggregated size that is based at least in part on a first quantity of bits that is based at least in part on the first quantity of SRS resources and the maximum rank, a second quantity of bits that is based at least in part on the second quantity of SRS resources and the maximum rank, and/or a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank. For example, the aggregated size of the first SRI and the second SRI may be a maximum of the first quantity of bits, the second quantity of bits, and the third quantity of bits. In other words, the aggregated size of the first SRI and the second SRI (e.g., needed to account for both mTRP and sTRP SDM communications), in examples for the SRS resources available for mTRP communications are subject to the restriction described above, may be the

$$max ( max [ ⌈ {log}_{2} ( {\sum }_{k = 1}^{min \{ {L}_{max} , {N}_{1} \}} ( \begin{matrix}{N}_{1} \\ k\end{matrix} ) ) ⌉ , \text{} ⌈ {log}_{2} ( {\sum }_{k = 1}^{min \{ {L}_{max} , {N}_{2} \}} ( \begin{matrix}{N}_{2} \\ k\end{matrix} ) ) ⌉ ] , \text{} ⌈ {log}_{2} ( {\sum }_{k = 1}^{min \{ \frac{{L}_{max}}{2} , {N}_{1} \}} ( \begin{matrix}min \{ \frac{{L}_{max}}{2} , {N}_{1} \} \\ k\end{matrix} ) ⌉ + ⌈ {log}_{2} ( {\sum }_{k = 1}^{min \{ {L}_{max} - \frac{{L}_{max}}{2} , {N}_{2} \}} ( \begin{matrix}min \{ {L}_{max} - \frac{{L}_{max}}{2} , {N}_{2} \} \\ k\end{matrix} ) ⌉ ) .$$

In examples where the SRS resources available for mTRP communications are not subject to the restriction described above, the aggregated size of the first SRI and the second SRI (e.g., needed to account for both mTRP and sTRP SDM communications) may be the

$$max ( max [ ⌈ {log}_{2} ( {\sum }_{k = 1}^{min \{ {L}_{max} , {N}_{1} \}} ( \begin{matrix}{N}_{1} \\ k\end{matrix} ) ) ⌉ , ⌈ {log}_{2} ( {\sum }_{k = 1}^{min \{ {L}_{max} , {N}_{2} \}} ( \begin{matrix}{N}_{2} \\ k\end{matrix} ) ) ⌉ ] , \\ ⌈ {log}_{2} ( {\sum }_{k = 1}^{min \{ \frac{{L}_{max}}{2} , {N}_{1} \}} ( \begin{matrix}{N}_{1} \\ k\end{matrix} ) ⌉ + ⌈ {log}_{2} ( {\sum }_{k = 1}^{min \{ {L}_{max} - \frac{{L}_{max}}{2} , {N}_{2} \}} ( \begin{matrix}{N}_{2} \\ k\end{matrix} ) ⌉ ) .$$

In examples where the first SRS resource set is associated with the first maximum rank Lₘₐₓ¹ and the second SRS resource set is associated with the second maximum rank Lₘₐₓ², the aggregated size of the first SRI and the second SRI (e.g., needed to account for both mTRP and sTRP SDM communications) may be the

$$max ( \begin{matrix}max [ ⌈ {log}_{2} ( {\sum }_{k = 1}^{min \{ {L}_{max} , {L}_{max}^{1} + {L}_{max}^{2} , {N}_{1} \}} ( \begin{matrix}{N}_{1} \\ k\end{matrix} ) ) ⌉ , ⌈ {log}_{2} ( {\sum }_{k = 1}^{min \{ {L}_{max} , {L}_{max}^{1} + {L}_{max}^{2} , {N}_{2} \}} ( \begin{matrix}{N}_{2} \\ k\end{matrix} ) ) ⌉ ] , \\ ⌈ {log}_{2} ( {\sum }_{k = 1}^{min \{ {L}_{max}^{1} , {N}_{1} \}} ( \begin{matrix}{N}_{1} \\ k\end{matrix} ) ⌉ + ⌈ {log}_{2} ( {\sum }_{k = 1}^{min \{ {L}_{max}^{2} , {N}_{2} \}} ( \begin{matrix}{N}_{2} \\ k\end{matrix} ) ⌉\end{matrix} ) .$$

The following tables provide examples of a size of SRIs included in DCI for SDM communications (e.g., for both sTRP communications and mTRP communications). In the tables, an entry includes information indicating an aggregated size for SRIs for joint indications (e.g., for sTRP communications when SDM is configured) and a size of each SRI for mTRP communications. For example, the entries indicate (an aggregated size for SRIs for joint indications), (a size of the first SRI for mTRP communications)+(a size of the second SRI for mTRP communications). The sizes indicate may be a quantity of bits.

TABLE 1

N₁

| | | 4 | 3 | 2 | 1 |
|---|---|---|---|---|---|
| N₂ | 4 | 4, 2 + 2 | 4, 2 + 2 | 4, 2 + 2 | 4, 2 + 0 |
| | 3 | 4, 2 + 2 | 3, 2 + 2 | 3, 2 + 2 | 3, 2 + 0 |
| | 2 | 4, 2 + 2 | 3, 2 + 2 | 2, 2 + 2 | 2, 2 + 0 |
| | 1 | 4, 0 + 2 | 3, 0 + 2 | 2, 0 + 2 | 0, 0 + 0 |

Table 1 is associated with a maximum rank, Lₘₐₓ, of 4. Additionally, Table 1 depicts an example in which SRS resources available for selection for mTRP communications are subject to the restriction described above. The entries associated with (N₁, N₂) values of (4, 4), (3, 4), (2, 4), (4, 3), (4, 2), (2, 1), (1, 2), and (1,1) may not be associated with zero-padding (e.g., no zero-padding may be needed for this scenarios). “Zero-padding” may refer to extending a signal with values of zero (e.g., “0”) to extend the length of the signal (e.g., in the time domain). The entries associated with (N1, N2) values of (3, 3), (3, 2), (2, 3), and (2, 2) may be associated with zero-padding for the sTRP joint SRI indications. The entries associated with (N1, N2) values of (1, 4), (1, 3), (4, 1), and (3, 1) may be associated with zero-padding for the mTRP SRI indications.

TABLE 2

N₁

| | | 4 | 3 | 2 | 1 |
|---|---|---|---|---|---|
| N₂ | 4 | 4, 2 + 0 | 4, 2 + 0 | 4, 2 + 0 | 4, 2 + 0 |
| | 3 | 4, 2 + 0 | 3, 2 + 0 | 3, 2 + 0 | 3, 2 + 0 |
| | 2 | 4, 2 + 0 | 3, 2 + 0 | 2, 2 + 0 | 2, 2 + 0 |
| | 1 | 4, 0 + 0 | 3, 0 + 0 | 2, 0 + 0 | 0, 0 + 0 |

Table 2 is associated with a maximum rank, Lₘₐₓ, of 3. Additionally, Table 2 depicts an example in which SRS resources available for selection for mTRP communications are subject to the restriction described above. The entries associated with (N₁, N₂) values of (2, 2), (2, 1), and (1,1) may not be associated with zero-padding (e.g., no zero-padding may be needed for this scenarios). The remaining entries in Table 2 may be associated with zero-padding for the mTRP SRI indications.

TABLE 3

N₁

| N₂ | 4 | 3 | 2 | 1 |
|---|---|---|---|---|
| 4 | 4, 0 + 0 | 4, 0 + 0 | 4, 0 + 0 | 4, 0 + 0 |
| 3 | 4, 0 + 0 | 3, 0 + 0 | 3, 0 + 0 | 3, 0 + 0 |
| 2 | 4, 0 + 0 | 3, 0 + 0 | 2, 0 + 0 | 2, 0 + 0 |
| 1 | 4, 0 + 0 | 3, 0 + 0 | 2, 0 + 0 | 0, 0 + 0 |

Table 3 is associated with a maximum rank, Lₘₐₓ, of 2. Additionally, Table 3 depicts an example in which SRS resources available for selection for mTRP communications are subject to the restriction described above. The entry associated with (N₁, N₂) values of (1, 1) may not be associated with zero-padding (e.g., no zero-padding may be needed for this scenario). The remaining entries in Table 3 may be associated with zero-padding for the mTRP SRI indications.

TABLE 4

N₁

| | | 4 | 3 | 2 | 1 |
|---|---|---|---|---|---|
| N₂ | 4 | 4, 4 + 4 | 4, 4 + 3 | 4, 4 + 2 | 4, 4 + 0 |
| | 3 | 4, 3 + 4 | 3, 3 + 3 | 3, 3 + 2 | 3, 3 + 0 |
| | 2 | 4, 2 + 4 | 3, 2 + 3 | 2, 2 + 2 | 2, 2 + 0 |
| | 1 | 4, 0 + 4 | 3, 0 + 3 | 2, 0 + 2 | 0, 0 + 0 |

Table 4 is associated with a maximum rank, Lₘₐₓ, of 4. Additionally, Table 4 depicts an example in which SRS resources available for selection for mTRP communications are not subject to the restriction described above. The entries associated with (N₁, N₂) values of (4, 1), (3, 1), (2, 1), (1, 1), (1, 4), (1, 3), and (1, 2), may not be associated with zero-padding (e.g., no zero-padding may be needed for this scenarios). The remaining entries in Table 4 may be associated with zero-padding for the sTRP joint SRI indications.

TABLE 5

N₁

| | | 4 | 3 | 2 | 1 |
|---|---|---|---|---|---|
| N₂ | 4 | 4, 4 + 2 | 4, 4 + 2 | 4, 4 + 1 | 4, 4 + 0 |
| | 3 | 4, 3 + 2 | 3, 3 + 2 | 3, 3 + 1 | 3, 3 + 0 |
| | 2 | 4, 2 + 2 | 3, 2 + 2 | 2, 2 + 1 | 2, 2 + 0 |
| | 1 | 4, 0 + 2 | 3, 0 + 2 | 2, 0 + 1 | 0, 0 + 0 |

Table 5 is associated with a maximum rank, Lₘₐₓ, of 3. Additionally, Table 5 depicts an example in which SRS resources available for selection for mTRP communications are not subject to the restriction described above. The entries associated with (N₁, N₂) values of (4, 1), (3, 1), (2, 1), (2, 4), and (1, 1) may not be associated with zero-padding (e.g., no zero-padding may be needed for this scenarios). The entries associated with (N₁, N₂) values of (1, 4), (1, 3), and (1, 2) may be associated with zero-padding for the mTRP SRI indications. The remaining entries in Table 5 may be associated with zero-padding for the sTRP joint SRI indications.

TABLE 6

N₁

| | | 4 | 3 | 2 | 1 |
|---|---|---|---|---|---|
| N₂ | 4 | 4, 2 + 2 | 4, 2 + 2 | 4, 2 + 1 | 4, 2 + 0 |
| | 3 | 4, 2 + 2 | 3, 2 + 2 | 3, 2 + 1 | 3, 2 + 0 |
| | 2 | 4, 1 + 2 | 3, 1 + 2 | 2, 1 + 1 | 2, 1 + 0 |
| | 1 | 4, 0 + 2 | 3, 0 + 2 | 2, 0 + 1 | 0, 0 + 0 |

Table 6 is associated with a maximum rank, Lₘₐₓ, of 2. Additionally, Table 6 depicts an example in which SRS resources available for selection for mTRP communications are not subject to the restriction described above. The entries associated with (N₁, N₂) values of (4, 4), (4, 3), (3, 4), (3, 2), (2, 3), (2, 2), and (1, 1) may not be associated with zero-padding (e.g., no zero-padding may be needed for this scenario). The entry associated with (N₁, N₂) values of (3, 3) may be associated with zero-padding for the sTRP joint SRI indications. The remaining entries in Table 6 may be associated with zero-padding for the mTRP SRI indications.

TABLE 7

N₁

| | | 4 | 3 | 2 | 1 |
|---|---|---|---|---|---|
| N₂ | 4 | 4, 4 + 2 | 4, 4 + 2 | 4, 4 + 1 | 4, 4 + 0 |
| | 3 | 4, 3 + 2 | 3, 3 + 2 | 3, 3 + 1 | 3, 3 + 0 |
| | 2 | 4, 2 + 2 | 3, 2 + 2 | 2, 2 + 1 | 2, 2 + 0 |
| | 1 | 4, 0 + 2 | 3, 0 + 2 | 2, 0 + 1 | 0, 0 + 0 |

Table 7 is associated with a maximum rank, Lₘₐₓ, of 4. Additionally, Table 5 depicts an example in which the first SRS resource set is associated with a first maximum rank, Lₘₐₓ¹, and the second SRS resource set is associated with a second maximum rank, Lₘₐₓ². Table 7 depicts an example in which Lₘₐₓ¹ is 3 and Lₘₐₓ² is 1. The entries associated with (N₁, N₂) values of (4, 2), (4, 1), (3, 1), (2, 1), and (1, 1) may not be associated with zero-padding (e.g., no zero-padding may be needed for this scenarios). The entries associated with (N₁, N₂) values of (1, 4), (1, 3), and (1, 2) may be associated with zero-padding for the mTRP SRI indications. The remaining entries in Table 5 may be associated with zero-padding for the sTRP joint SRI indications.

As shown by reference number 715, the UE 120 may determine SRS resources indicated by the DCI and/or SRS resource-to-layer mapping indicated by the DCI. For example, the UE 120 may determine an SRI-to-SRS resource set associated for the SRIs included in the DCI. The UE 120 may identify SRS resources associated with a first set of layers for the SDM communication scheduled by the DCI. The UE 120 may identify a beam and/or a set of power control parameters for the first set of layers based at least in part on the identified SRS resources associated with a first set of layers. Additionally, the UE 120 may identify SRS resources associated with a second set of layers for the SDM communication scheduled by the DCI. The UE 120 may identify a beam and/or a set of power control parameters for the second set of layers based at least in part on the identified SRS resources associated with a second set of layers. In some aspects, whether the SDM communication scheduled by the DCI is an sTRP communication (e.g., associated with a single SRS resource set) or an mTRP communication (e.g., associated with multiple SRS resource sets) may be indicated by the DCI (e.g., via the dynamic switching indicator included in the DCI).

As shown by reference number 720, the UE 120 may transmit, and the base station 110 may receive, the SDM communication (e.g., the SDM PUSCH communication) that is scheduled by the DCI using the first one or more SRS resources for the first one or more layers (e.g., to identify a beam and/or power control parameters for the first one or more layers) and the second one or more SRS resources for the second one or more layers (e.g., to identify a beam and/or power control parameters for the second one or more layers). For example, the UE 120 may transmit the first one or more layers using a first beam, a first set of power control parameters, and/or a first set of transmission parameters that are associated with the first one or more SRS resources. The UE 120 may transmit the second one or more layers using a second beam, a second set of power control parameters, and/or a second set of transmission parameters that are associated with the second one or more SRS resources. As described elsewhere herein, the SDM communication (e.g., the SDM PUSCH communication) may be a non-codebook based PUSCH communication.

As indicated above, FIG. 7 is provided as an example. Other examples may differ from what is described with respect to FIG. 7.

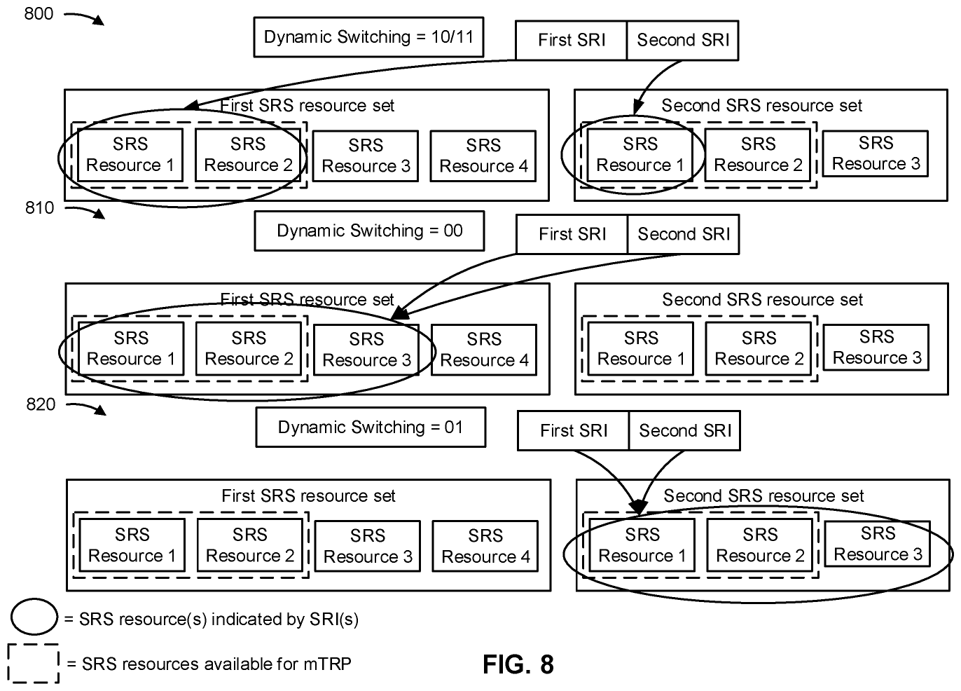

FIG. 8 is a diagram illustrating examples 800, 810, and 820 associated with SRI signaling for SDM communications, in accordance with the present disclosure. Example 800 depicts DCI indicating SRS resources associated with an mTRP SDM PUSCH communication. Examples 810 and 820 depict DCI indicating SRS resources associated with sTRP SDM PUSCH communications.

As shown in FIG. 8, and example 800, DCI may indicate that the DCI is scheduling an mTRP communication via a dynamic switching indicator (e.g., a dynamic switching filed). For example, a value (e.g., codepoint) of the dynamic switching indicator of “10” and/or “11” may indicate that the DCI is scheduling an mTRP communication. In such examples, a first SRI included in the DCI may indicate a first one or more SRS resources from a first SRS resource set. A second SRI included in the DCI may indicate a second one or more SRS resource from a second SRS resource set. The first one or more SRS resources may be associated with a first one or more layers of the SDM PUSCH communication scheduled by the DCI and the second one or more SRS resources may be associated with a second one or more layers of the SDM PUSCH communication scheduled by the DCI. For example, as shown in FIG. 8, the first SRI may indicate a first SRS resource (e.g., SRS resource 1) and a second SRS resource (e.g., SRS resource 2) from the first SRS resource set. The second SRI may indicate a first SRS resource (e.g., SRS resource 1) from the second SRS resource set.

In some aspects, a restriction may indicate that only a subset of SRS resources, from the SRS resources included in an SRS resource set, are available to be selected for mTRP communications. For example, as shown in FIG. 8, for the first SRS resource set, only the first SRS resource (e.g., SRS resource 1) and the second SRS resource (e.g., SRS resource 2) from the first SRS resource set are available to be selected for mTRP communications. Similarly, for the second SRS resource set, only the first SRS resource (e.g., SRS resource 1) and the second SRS resource (e.g., SRS resource 2) from the second SRS resource set are available to be selected for mTRP communications. A determination of quantity of the SRS resources available to be selected for mTRP communications (e.g., the quantity of SRS resources included in each subset) is described in more detail elsewhere herein, such as in connection with FIG. 7.

In some other aspects, the restriction may not be in place. In such examples, all SRS resources included in an SRS resource set may be available for selection (e.g., by a base station) for mTRP communications. For example, rather than only the first SRS resource (e.g., SRS resource 1) and the second SRS resource (e.g., SRS resource 2) from the first SRS resource set being available to be selected, the first SRI may indicate one or more SRS resources from the first SRS resource (e.g., SRS resource 1), the second SRS resource (e.g., SRS resource 2), a third SRS resource (e.g., SRS resource 3), and a fourth SRS resource (e.g., SRS resource 4) for mTRP communications.

As shown in example 810, in some cases, the first SRI and the second SRI may jointly indicate one or more SRS resources from the first SRS resource set (e.g., for an sTRP communication). For example, the dynamic switching indicator may indicate that the DCI is scheduling an sTRP communication and may indicate that the first SRS resource set is associated with a joint indication provided by the first SRI and the second SRI (e.g., based at least in part on the value (e.g., codepoint) of “00” being included in the dynamic switching field of the DCI). For example, as shown in FIG. 8, the first SRI and the second SRI may jointly indicate the first SRS resource (e.g., SRS resource 1), the second SRS resource (e.g., SRS resource 2), and the third SRS resource (e.g., SRS resource 3) from the first SRS resource set. The SRS resources may be used to identify beams and/or power control parameters for different sets of layers for an STRP SDM PUSCH communication scheduled by the DCI.

As shown in example 820, the first SRI and the second SRI may jointly indicate one or more SRS resources from the second SRS resource set (e.g., for an sTRP communication). For example, the dynamic switching indicator may indicate that the DCI is scheduling an sTRP communication and may indicate that the second SRS resource set is associated with a joint indication provided by the first SRI and the second SRI (e.g., based at least in part on the value (e.g., codepoint) of “01” being included in the dynamic switching field of the DCI). For example, as shown in FIG. 8, the first SRI and the second SRI may jointly indicate the first SRS resource (e.g., SRS resource 1), the second SRS resource (e.g., SRS resource 2), and the third SRS resource (e.g., SRS resource 3) from the second SRS resource set. The SRS resources may be used to identify beams and/or power control parameters for different sets of layers for an sTRP SDM PUSCH communication scheduled by the DCI.

As indicated above, FIG. 8 is provided as an example. Other examples may differ from what is described with respect to FIG. 8.

FIG. 9 is a diagram illustrating an example process 900 performed, for example, by a UE, in accordance with the present disclosure. Example process 900 is an example where the UE (e.g., UE 120) performs operations associated with SRI signaling for SDM communications.

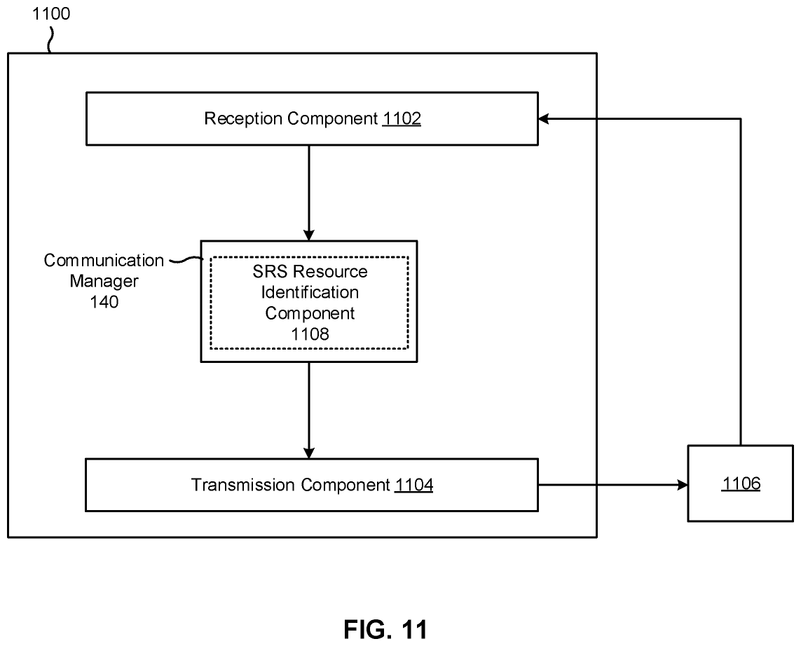

As shown in FIG. 9, in some aspects, process 900 may include receiving, from a base station, configuration information associated with a first SRS resource set and a second SRS resource set, wherein the first SRS resource set includes a first quantity of SRS resources and the second SRS resource set includes a second quantity of SRS resources (block 910). For example, the UE (e.g., using communication manager 140 and/or reception component 1102, depicted in FIG. 11) may receive, from a base station, configuration information associated with a first SRS resource set and a second SRS resource set, wherein the first SRS resource set includes a first quantity of SRS resources and the second SRS resource set includes a second quantity of SRS resources, as described above, for example, with reference to FIGS. 7 and/or 8.

As further shown in FIG. 9, in some aspects, process 900 may include receiving, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication (block 920). For example, the UE (e.g., using communication manager 140 and/or reception component 1102, depicted in FIG. 11) may receive, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication, as described above, for example, with reference to FIGS. 7 and/or 8. For example, the DCI may jointly indicate (e.g., the first SRI and the second SRI may jointly indicate) the first one or more SRS resources and the second one or more SRS resources from the first SRS resource set. As another example, the DCI may jointly indicate (e.g., the first SRI and the second SRI may jointly indicate) the first one or more SRS resources and the second one or more SRS resources from the second SRS resource set. As another example, the DCI may indicate (e.g., via the first SRI) the first one or more SRS resources from the first SRS resource set and the DCI may indicate (e.g., via the second SRI) the second one or more SRS resources from the second SRS resource set.

Process 900 may include additional aspects, such as any single aspect or any combination of aspects described below and/or in connection with one or more other processes described elsewhere herein.

In a first aspect, process 900 includes transmitting the spatial division multiplexing PUSCH communication using the first one or more SRS resources for the first one or more layers and the second one or more SRS resources for the second one or more layers.

In a second aspect, alone or in combination with the first aspect, transmitting the spatial division multiplexing PUSCH communication includes transmitting the first one or more layers using a first beam or a first set of transmission parameters associated with the first one or more SRS resources, and transmitting the second one or more layers using a second beam or a second set of transmission parameters associated with the second one or more SRS resources.

In a third aspect, alone or in combination with one or more of the first and second aspects, the spatial division multiplexing PUSCH communication is a non-codebook based PUSCH communication.

In a fourth aspect, alone or in combination with one or more of the first through third aspects, the first SRI and the second SRI are associated with an aggregated size that is based at least in part on a first quantity of bits that is based at least in part on the first quantity of SRS resources and the maximum rank, or a second quantity of bits that is based at least in part on the second quantity of SRS resources and the maximum rank.

In a fifth aspect, alone or in combination with one or more of the first through fourth aspects, the first SRI and the second SRI jointly indicate the first one or more SRS resources and the second one or more SRS resources, from the first SRS resource set, based at least in part on the dynamic switching indicator being associated with a first value; or the first one or more SRS resources and the second one or more SRS resources, from the second SRS resource set, based at least in part on the dynamic switching indicator being associated with a second value.

In a sixth aspect, alone or in combination with one or more of the first through fifth aspects, a quantity of the first one or more SRS resources and the second one or more SRS resources from the first SRS resource set is based at least in part on the first quantity of SRS resources and the maximum rank, and a quantity of the first one or more SRS resources and the second one or more SRS resources from the second SRS resource set is based at least in part on the second quantity of SRS resources and the maximum rank.

In a seventh aspect, alone or in combination with one or more of the first through sixth aspects, the DCI indicates SRS resources from both the first SRS resource set and the second SRS resource set, and wherein the DCI indicates up to a first maximum quantity of indicated SRS resources from a first subset of SRS resources, of the first SRS resource set, and up to a second quantity of indicated SRS resources from a second subset of SRS resources of the second SRS resource set.

In an eighth aspect, alone or in combination with one or more of the first through seventh aspects, a quantity of SRS resources included in the first subset of SRS resources is based at least in part on the first quantity of SRS resources and a portion of the maximum rank, and wherein a quantity of SRS resources included in the second subset of SRS resources is based at least in part on the second quantity of SRS resources and the portion of the maximum rank.

In a ninth aspect, alone or in combination with one or more of the first through eighth aspects, the first SRI indicates the first one or more SRS resources, from a first subset of SRS resources of the first SRS resource set, associated with the first one or more layers, and wherein the second SRI indicates the second one or more SRS resources, from a second subset of SRS resources of the second SRS resource set, associated with the second one or more layers.

In a tenth aspect, alone or in combination with one or more of the first through ninth aspects, the first SRI indicates up to a first maximum quantity of SRS resources from the first subset of SRS resources, and wherein the second SRI indicates up to a second maximum quantity of SRS resources from the second subset of SRS resources.

In an eleventh aspect, alone or in combination with one or more of the first through tenth aspects, the first SRI and the second SRI are associated with an aggregated size that is based at least in part on a first quantity of bits that is based at least in part on the first quantity of SRS resources and the maximum rank, a second quantity of bits that is based at least in part on the second quantity of SRS resources and the maximum rank, or a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank.

In a twelfth aspect, alone or in combination with one or more of the first through eleventh aspects, the configuration information indicates a third SRS resource set and a fourth SRS resource set, wherein a first set of SRS resources included in the first SRS resource set is included in the third SRS resource set, and wherein a second set of SRS resources included in the second SRS resource set is included in the fourth SRS resource set.

In a thirteenth aspect, alone or in combination with one or more of the first through twelfth aspects, a quantity of SRS resources included in the first set of SRS resources is based at least in part on the first quantity of SRS resources and a portion of the maximum rank, and wherein a quantity of SRS resources included in the second set of SRS resources is based at least in part on the second quantity of SRS resources and the portion of the maximum rank.

In a fourteenth aspect, alone or in combination with one or more of the first through thirteenth aspects, the DCI indicates SRS resources from both the first SRS resource set and the second SRS resource set, and wherein the DCI indicates up to a first maximum quantity of SRS resources from the first SRS resource set and up to a second maximum quantity of indicated SRS resources from the second SRS resource set.

In a fifteenth aspect, alone or in combination with one or more of the first through fourteenth aspects, the first maximum quantity of SRS resources is based at least in part on the first quantity of SRS resources and a portion of the maximum rank, and wherein the second maximum quantity of SRS resources is based at least in part on the second quantity of SRS resources and the portion of the maximum rank.

In a sixteenth aspect, alone or in combination with one or more of the first through fifteenth aspects, the first SRI indicates the first one or more SRS resources, from the first SRS resource set, associated with the first one or more layers, and wherein the second SRI indicates the second one or more SRS resources, from the second SRS resource set, associated with the second one or more layers.

In a seventeenth aspect, alone or in combination with one or more of the first through sixteenth aspects, the first SRI indicates up to a first maximum quantity of indicated SRS resources from the first SRS resource set, and wherein the second SRI indicates up to a second maximum quantity of indicated SRS resources from the second SRS resource set.

In an eighteenth aspect, alone or in combination with one or more of the first through seventeenth aspects, the first SRS resource set is associated with a first maximum rank and the second SRS resource set is associated with a second maximum rank.

In a nineteenth aspect, alone or in combination with one or more of the first through eighteenth aspects, the first SRI indicates up to a first maximum quantity of SRS resources from the first SRS resource set, wherein the first quantity is based at least in part on the first maximum rank and the first quantity of SRS resources, and wherein the second SRI indicates up to a second maximum quantity of SRS resources from the second SRS resource set, wherein the second quantity is based at least in part on the second maximum rank and the second quantity of SRS resources.

In a twentieth aspect, alone or in combination with one or more of the first through nineteenth aspects, the first SRI and the second SRI jointly indicate the first one or more SRS resources and the second one or more SRS resources, from the first SRS resource set, based at least in part on the dynamic switching indicator being associated with a first value; or the first one or more SRS resources and the second one or more SRS resources, from the second SRS resource set, based at least in part on the dynamic switching indicator being associated with a second value.

In a twenty-first aspect, alone or in combination with one or more of the first through twentieth aspects, a first maximum quantity associated with the first one or more SRS resources and the second one or more SRS resources from the first SRS resource set is based at least in part on the maximum rank, the first maximum rank, the second maximum rank, and the first quantity of SRS resources, and a second maximum quantity associated with the first one or more SRS resources and the second one or more SRS resources from the second SRS resource set is based at least in part on the maximum rank, the first maximum rank, the second maximum rank, and the second quantity of SRS resources.

Although FIG. 9 shows example blocks of process 900, in some aspects, process 900 may include additional blocks, fewer blocks, different blocks, or differently arranged blocks than those depicted in FIG. 9. Additionally, or alternatively, two or more of the blocks of process 900 may be performed in parallel.

FIG. 10 is a diagram illustrating an example process 1000 performed, for example, by a base station, in accordance with the present disclosure. Example process 1000 is an example where the base station (e.g., base station 110) performs operations associated with SRI signaling for SDM communications.

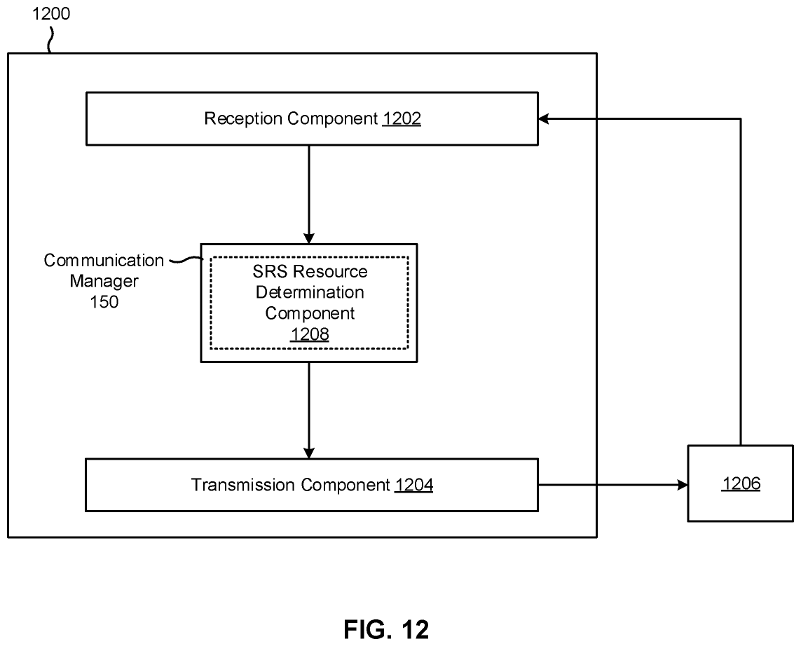

As shown in FIG. 10, in some aspects, process 1000 may include transmitting, to a UE, configuration information associated with a first SRS resource set and a second SRS resource set, wherein the first SRS resource set includes a first quantity of SRS resources and the second SRS resource set includes a second quantity of SRS resources (block 1010). For example, the base station (e.g., using communication manager 150 and/or transmission component 1204, depicted in FIG. 12) may transmit, to a UE, configuration information associated with a first SRS resource set and a second SRS resource set, wherein the first SRS resource set includes a first quantity of SRS resources and the second SRS resource set includes a second quantity of SRS resources, as described above, for example, with reference to FIGS. 7 and/or 8.

As further shown in FIG. 10, in some aspects, process 1000 may include transmitting, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication (block 1020). For example, the base station (e.g., using communication manager 150 and/or transmission component 1204, depicted in FIG. 12) may transmit, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication, as described above, for example, with reference to FIGS. 7 and/or 8. For example, the DCI may jointly indicate the first one or more SRS resources and the second one or more SRS resources from the first SRS resource set. As another example, the DCI may jointly indicate the first one or more SRS resources and the second one or more SRS resources from the second SRS resource set. As another example, the DCI may indicate the first one or more SRS resources from the first SRS resource set and may indicate the second one or more SRS resources from the second SRS resource set.

Process 1000 may include additional aspects, such as any single aspect or any combination of aspects described below and/or in connection with one or more other processes described elsewhere herein.

In a first aspect, process 1000 includes receiving, from the UE, the spatial division multiplexing PUSCH communication using the first one or more SRS resources for the first one or more layers and the second one or more SRS resources for the second one or more layers.

In a second aspect, alone or in combination with the first aspect, transmitting the spatial division multiplexing PUSCH communication includes receiving the first one or more layers using a first beam or a first set of transmission parameters associated with the first one or more SRS resources, and receiving the second one or more layers using a second beam or a second set of transmission parameters associated with the second one or more SRS resources.

In a third aspect, alone or in combination with one or more of the first and second aspects, the spatial division multiplexing PUSCH communication is a non-codebook based PUSCH communication.

In a fourth aspect, alone or in combination with one or more of the first through third aspects, the first SRI and the second SRI are associated with an aggregated size that is based at least in part on a first quantity of bits that is based at least in part on the first quantity of SRS resources and the maximum rank, or a second quantity of bits that is based at least in part on the second quantity of SRS resources and the maximum rank.

In a fifth aspect, alone or in combination with one or more of the first through fourth aspects, the first SRI and the second SRI jointly indicate: the first one or more SRS resources and the second one or more SRS resources, from the first SRS resource set, based at least in part on the dynamic switching indicator being associated with a first value; or the first one or more SRS resources and the second one or more SRS resources, from the second SRS resource set, based at least in part on the dynamic switching indicator being associated with a second value.

In a sixth aspect, alone or in combination with one or more of the first through fifth aspects, a quantity of the first one or more SRS resources and the second one or more SRS resources from the first SRS resource set is based at least in part on the first quantity of SRS resources and the maximum rank, and a quantity of the first one or more SRS resources and the second one or more SRS resources from the second SRS resource set is based at least in part on the second quantity of SRS resources and the maximum rank.

In a seventh aspect, alone or in combination with one or more of the first through sixth aspects, the DCI indicates SRS resources from both the first SRS resource set and the second SRS resource set, and the DCI indicates up to a first maximum quantity of SRS resources from a first subset of SRS resources, of the first SRS resource set, and up to a second maximum quantity of SRS resources from a second subset of SRS resources of the second SRS resource set.

In an eighth aspect, alone or in combination with one or more of the first through seventh aspects, a quantity of SRS resources included in the first subset of SRS resources is based at least in part on the first quantity of SRS resources and a portion of the maximum rank, and wherein a quantity of SRS resources included in the second subset of SRS resources is based at least in part on the second quantity of SRS resources and the portion of the maximum rank.

In a ninth aspect, alone or in combination with one or more of the first through eighth aspects, the first SRI indicates the first one or more SRS resources, from a first subset of SRS resources of the first SRS resource set, associated with the first one or more layers, and the second SRI indicates the second one or more SRS resources, from a second subset of SRS resources of the second SRS resource set, associated with the second one or more layers.

In a tenth aspect, alone or in combination with one or more of the first through ninth aspects, the first SRI indicates up to a first maximum quantity of SRS resources from the first subset of SRS resources, and the second SRI indicates up to a second maximum quantity of SRS resources from the second subset of SRS resources.

In an eleventh aspect, alone or in combination with one or more of the first through tenth aspects, the first SRI and the second SRI are associated with an aggregated size that is based at least in part on a first quantity of bits that is based at least in part on the first quantity of SRS resources and the maximum rank, a second quantity of bits that is based at least in part on the second quantity of SRS resources and the maximum rank, or a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank.

In a twelfth aspect, alone or in combination with one or more of the first through eleventh aspects, the configuration information indicates a third SRS resource set and a fourth SRS resource set, where a first set of SRS resources included in the first SRS resource set is included in the third SRS resource set, and a second set of SRS resources included in the second SRS resource set is included in the fourth SRS resource set.

In a thirteenth aspect, alone or in combination with one or more of the first through twelfth aspects, a quantity of SRS resources included in the first set of SRS resources is based at least in part on the first quantity of SRS resources and a portion of the maximum rank, and a quantity of SRS resources included in the second set of SRS resources is based at least in part on the second quantity of SRS resources and the portion of the maximum rank.

In a fourteenth aspect, alone or in combination with one or more of the first through thirteenth aspects, the DCI indicates SRS resources from both the first SRS resource set and the second SRS resource set, and the DCI indicates up to a first maximum quantity of SRS resources from the first SRS resource set and up to a second maximum quantity of SRS resources from the second SRS resource set.

In a fifteenth aspect, alone or in combination with one or more of the first through fourteenth aspects, the first maximum quantity of SRS resources is based at least in part on the first quantity of SRS resources and a portion of the maximum rank, and the second maximum quantity of SRS resources is based at least in part on the second quantity of SRS resources and the portion of the maximum rank.

In a sixteenth aspect, alone or in combination with one or more of the first through fifteenth aspects, the first SRI indicates the first one or more SRS resources, from the first SRS resource set, associated with the first one or more layers, and the second SRI indicates the second one or more SRS resources, from the second SRS resource set, associated with the second one or more layers.

In a seventeenth aspect, alone or in combination with one or more of the first through sixteenth aspects, the first SRI indicates up to a first maximum quantity of SRS resources from the first SRS resource set, and the second SRI indicates up to a second maximum quantity of SRS resources from the second SRS resource set.

In an eighteenth aspect, alone or in combination with one or more of the first through seventeenth aspects, the first SRS resource set is associated with a first maximum rank and the second SRS resource set is associated with a second maximum rank.

In a nineteenth aspect, alone or in combination with one or more of the first through eighteenth aspects, the first SRI indicates up to a first maximum quantity of SRS resources from the first SRS resource set, where the first maximum quantity is based at least in part on the first maximum rank and the first quantity of SRS resources, and the second SRI indicates up to a second maximum quantity of SRS resources from the second SRS resource set, where the second maximum quantity is based at least in part on the second maximum rank and the second quantity of SRS resources.

In a twentieth aspect, alone or in combination with one or more of the first through nineteenth aspects, the first SRI and the second SRI jointly indicate: the first one or more SRS resources and the second one or more SRS resources, from the first SRS resource set, based at least in part on the dynamic switching indicator being associated with a first value; or the first one or more SRS resources and the second one or more SRS resources, from the second SRS resource set, based at least in part on the dynamic switching indicator being associated with a second value.

In a twenty-first aspect, alone or in combination with one or more of the first through twentieth aspects, a first maximum quantity associated with the first one or more SRS resources and the second one or more SRS resources from the first SRS resource set is based at least in part on the maximum rank, the first maximum rank, the second maximum rank, and the first quantity of SRS resources, and a second maximum quantity associated with the first one or more SRS resources and the second one or more SRS resources from the second SRS resource set is based at least in part on the maximum rank, the first maximum rank, the second maximum rank, and the second quantity of SRS resources.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram of an example apparatus 1100 for wireless communication. The apparatus 1100 may be a UE, or a UE may include the apparatus 1100. In some aspects, the apparatus 1100 includes a reception component 1102 and a transmission component 1104, which may be in communication with one another (for example, via one or more buses and/or one or more other components). As shown, the apparatus 1100 may communicate with another apparatus 1106 (such as a UE, a base station, or another wireless communication device) using the reception component 1102 and the transmission component 1104. As further shown, the apparatus 1100 may include the communication manager 140. The communication manager 140 may include an SRS resource identification component 1108, among other examples.

In some aspects, the apparatus 1100 may be configured to perform one or more operations described herein in connection with FIGS. 7 and 8. Additionally, or alternatively, the apparatus 1100 may be configured to perform one or more processes described herein, such as process 900 of FIG. 9, or a combination thereof. In some aspects, the apparatus 1100 and/or one or more components shown in FIG. 11 may include one or more components of the UE described in connection with FIG. 2. Additionally, or alternatively, one or more components shown in FIG. 11 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1102 may receive communications, such as reference signals, control information, data communications, or a combination thereof, from the apparatus 1106. The reception component 1102 may provide received communications to one or more other components of the apparatus 1100. In some aspects, the reception component 1102 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1100. In some aspects, the reception component 1102 may include one or more antennas, a modem, a demodulator, a MIMO detector, a receive processor, a controller/processor, a memory, or a combination thereof, of the UE described in connection with FIG. 2.

The transmission component 1104 may transmit communications, such as reference signals, control information, data communications, or a combination thereof, to the apparatus 1106. In some aspects, one or more other components of the apparatus 1100 may generate communications and may provide the generated communications to the transmission component 1104 for transmission to the apparatus 1106. In some aspects, the transmission component 1104 may perform signal processing on the generated communications (such as filtering, amplification, modulation, digital-to-analog conversion, multiplexing, interleaving, mapping, or encoding, among other examples), and may transmit the processed signals to the apparatus 1106. In some aspects, the transmission component 1104 may include one or more antennas, a modem, a modulator, a transmit MIMO processor, a transmit processor, a controller/processor, a memory, or a combination thereof, of the UE described in connection with FIG. 2. In some aspects, the transmission component 1104 may be co-located with the reception component 1102 in a transceiver.

The reception component 1102 may receive, from a base station, configuration information associated with a first SRS resource set and a second SRS resource set, wherein the first SRS resource set includes a first quantity of SRS resources and the second SRS resource set includes a second quantity of SRS resources. The reception component 1102 may receive, from the base station, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

The transmission component 1104 may transmit the spatial division multiplexing PUSCH communication using the first one or more SRS resources for the first one or more layers and the second one or more SRS resources for the second one or more layers.

The SRS resource identification component 1108 may identify the first one or more SRS resources associated with the first one or more layers and the second one or more SRS resources associated with the second one or more layers based at least in part on the DCI. For example, the SRS resource identification component 1108 may identify the first one or more SRS resources associated with the first one or more layers and the second one or more SRS resources associated with the second one or more layers based at least in part on the first SRI and/or the second SRI.

The number and arrangement of components shown in FIG. 11 are provided as an example. In practice, there may be additional components, fewer components, different components, or differently arranged components than those shown in FIG. 11. Furthermore, two or more components shown in FIG. 11 may be implemented within a single component, or a single component shown in FIG. 11 may be implemented as multiple, distributed components. Additionally, or alternatively, a set of (one or more) components shown in FIG. 11 may perform one or more functions described as being performed by another set of components shown in FIG. 11.

FIG. 12 is a diagram of an example apparatus 1200 for wireless communication. The apparatus 1200 may be a base station, or a base station may include the apparatus 1200. In some aspects, the apparatus 1200 includes a reception component 1202 and a transmission component 1204, which may be in communication with one another (for example, via one or more buses and/or one or more other components). As shown, the apparatus 1200 may communicate with another apparatus 1206 (such as a UE, a base station, or another wireless communication device) using the reception component 1202 and the transmission component 1204. As further shown, the apparatus 1200 may include the communication manager 150. The communication manager 150 may include an SRS resource determination component 1208, among other examples.

In some aspects, the apparatus 1200 may be configured to perform one or more operations described herein in connection with FIGS. 7 and 8. Additionally, or alternatively, the apparatus 1200 may be configured to perform one or more processes described herein, such as process 1000 of FIG. 10, or a combination thereof. In some aspects, the apparatus 1200 and/or one or more components shown in FIG. 12 may include one or more components of the base station described in connection with FIG. 2. Additionally, or alternatively, one or more components shown in FIG. 12 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1202 may receive communications, such as reference signals, control information, data communications, or a combination thereof, from the apparatus 1206. The reception component 1202 may provide received communications to one or more other components of the apparatus 1200. In some aspects, the reception component 1202 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1200. In some aspects, the reception component 1202 may include one or more antennas, a modem, a demodulator, a MIMO detector, a receive processor, a controller/processor, a memory, or a combination thereof, of the base station described in connection with FIG. 2.

The transmission component 1204 may transmit communications, such as reference signals, control information, data communications, or a combination thereof, to the apparatus 1206. In some aspects, one or more other components of the apparatus 1200 may generate communications and may provide the generated communications to the transmission component 1204 for transmission to the apparatus 1206. In some aspects, the transmission component 1204 may perform signal processing on the generated communications (such as filtering, amplification, modulation, digital-to-analog conversion, multiplexing, interleaving, mapping, or encoding, among other examples), and may transmit the processed signals to the apparatus 1206. In some aspects, the transmission component 1204 may include one or more antennas, a modem, a modulator, a transmit MIMO processor, a transmit processor, a controller/processor, a memory, or a combination thereof, of the base station described in connection with FIG. 2. In some aspects, the transmission component 1204 may be co-located with the reception component 1202 in a transceiver.

The transmission component 1204 may transmit, to a UE, configuration information associated with a first SRS resource set and a second SRS resource set, wherein the first SRS resource set includes a first quantity of SRS resources and the second SRS resource set includes a second quantity of SRS resources. The transmission component 1204 may transmit, to the UE, DCI scheduling a spatial division multiplexing PUSCH communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRI included in the DCI, a second SRI included in the DCI, the first quantity of SRS resources, the second quantity of SRS resources, or a maximum rank associated with the spatial division multiplexing PUSCH communication.

The reception component 1202 may receive, from the UE, the spatial division multiplexing PUSCH communication using the first one or more SRS resources for the first one or more layers and the second one or more SRS resources for the second one or more layers.

The SRS resource determination component 1208 may determine the first one or more SRS resources, from the first SRS resource set, and the second one or more SRS resources, from the second SRS resource set, to be associated with the spatial division multiplexing PUSCH communication.

The number and arrangement of components shown in FIG. 12 are provided as an example. In practice, there may be additional components, fewer components, different components, or differently arranged components than those shown in FIG. 12. Furthermore, two or more components shown in FIG. 12 may be implemented within a single component, or a single component shown in FIG. 12 may be implemented as multiple, distributed components. Additionally, or alternatively, a set of (one or more) components shown in FIG. 12 may perform one or more functions described as being performed by another set of components shown in FIG. 12.

The following provides an overview of some Aspects of the present disclosure:
Aspect 1: A method of wireless communication performed by a user equipment (UE), comprising: receiving, from a base station, configuration information associated with a first sounding reference signal (SRS) resource set and a second SRS resource set, wherein the first SRS resource set includes a first quantity of SRS resources and the second SRS resource set includes a second quantity of SRS resources; and receiving, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.
Aspect 2: The method of Aspect 1, further comprising: transmitting the spatial division multiplexing PUSCH communication using the first one or more SRS resources for the first one or more layers and the second one or more SRS resources for the second one or more layers.
Aspect 3: The method of Aspect 2, wherein transmitting the spatial division multiplexing PUSCH communication comprises: transmitting the first one or more layers using a first beam or a first set of transmission parameters associated with the first one or more SRS resources; and transmitting the second one or more layers using a second beam or a second set of transmission parameters associated with the second one or more SRS resources.
Aspect 4: The method of any of Aspects 1-3, wherein the spatial division multiplexing PUSCH communication is a non-codebook based PUSCH communication.
Aspect 5: The method of any of Aspects 1-4, wherein the first SRI and the second SRI are associated with an aggregated size that is based at least in part on: a first quantity of bits that is based at least in part on the first quantity of SRS resources and the maximum rank, or a second quantity of bits that is based at least in part on the second quantity of SRS resources and the maximum rank.
Aspect 6: The method of any of Aspects 1-5, wherein the first SRI and the second SRI jointly indicate: the first one or more SRS resources and the second one or more SRS resources, from the first SRS resource set, based at least in part on the dynamic switching indicator being associated with a first value, or the first one or more SRS resources and the second one or more SRS resources, from the second SRS resource set, based at least in part on the dynamic switching indicator being associated with a second value.
Aspect 7: The method of Aspect 6, wherein a quantity of the first one or more SRS resources and the second one or more SRS resources from the first SRS resource set is based at least in part on the first quantity of SRS resources and the maximum rank, and wherein a quantity of the first one or more SRS resources and the second one or more SRS resources from the second SRS resource set is based at least in part on the second quantity of SRS resources and the maximum rank.
Aspect 8: The method of any of Aspects 1-7, wherein the DCI indicates SRS resources from both the first SRS resource set and the second SRS resource set; and wherein the DCI indicates up to a first maximum quantity of SRS resources from a first subset of SRS resources, of the first SRS resource set, and up to a second maximum quantity of SRS resources from a second subset of SRS resources of the second SRS resource set.
Aspect 9: The method of Aspect 8, wherein a quantity of SRS resources included in the first subset of SRS resources is based at least in part on the first quantity of SRS resources and a portion of the maximum rank, and wherein a quantity of SRS resources included in the second subset of SRS resources is based at least in part on the second quantity of SRS resources and the portion of the maximum rank.
Aspect 10: The method of any of Aspects 1-9, wherein the first SRI indicates the first one or more SRS resources, from a first subset of SRS resources of the first SRS resource set, associated with the first one or more layers, and wherein the second SRI indicates the second one or more SRS resources, from a second subset of SRS resources of the second SRS resource set, associated with the second one or more layers.
Aspect 11: The method of Aspect 10, wherein the first SRI indicates up to a first maximum quantity of SRS resources from the first subset of SRS resources; and wherein the second SRI indicates up to a second maximum quantity of SRS resources from the second subset of SRS resources.
Aspect 12: The method of any of Aspects 1-11, wherein the first SRI and the second SRI are associated with an aggregated size that is based at least in part on: a first quantity of bits that is based at least in part on the first quantity of SRS resources and the maximum rank, a second quantity of bits that is based at least in part on the second quantity of SRS resources and the maximum rank, or a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank.
Aspect 13: The method of any of Aspects 1-12, wherein the configuration information indicates a third SRS resource set and a fourth SRS resource set, wherein a first set of SRS resources included in the first SRS resource set is included in the third SRS resource set, and wherein a second set of SRS resources included in the second SRS resource set is included in the fourth SRS resource set.
Aspect 14: The method of Aspect 13, wherein a quantity of SRS resources included in the first set of SRS resources is based at least in part on the first quantity of SRS resources and a portion of the maximum rank, and wherein a quantity of SRS resources included in the second set of SRS resources is based at least in part on the second quantity of SRS resources and the portion of the maximum rank.
Aspect 15: The method of any of Aspects 1-14, wherein the DCI indicates SRS resources from both the first SRS resource set and the second SRS resource set; and wherein the DCI indicates up to a first maximum quantity of SRS resources from the first SRS resource set and up to a second maximum quantity of SRS resources from the second SRS resource set.
Aspect 16: The method of Aspect 15, wherein the first maximum quantity of SRS resources is based at least in part on the first quantity of SRS resources and a portion of the maximum rank, and wherein the second maximum quantity of SRS resources is based at least in part on the second quantity of SRS resources and the portion of the maximum rank.
Aspect 17: The method of any of Aspects 1-16, wherein the first SRI indicates the first one or more SRS resources, from the first SRS resource set, associated with the first one or more layers, and wherein the second SRI indicates the second one or more SRS resources, from the second SRS resource set, associated with the second one or more layers.
Aspect 18: The method of Aspect 17, wherein the first SRI indicates up to a first maximum quantity of SRS resources from the first SRS resource set; and wherein the second SRI indicates up to a second maximum quantity of SRS resources from the second SRS resource set.
Aspect 19: The method of any of Aspects 1-18, wherein the first SRS resource set is associated with a first maximum rank and the second SRS resource set is associated with a second maximum rank.
Aspect 20: The method of Aspect 19, wherein the first SRI indicates up to a first maximum quantity of SRS resources from the first SRS resource set, wherein the first maximum quantity is based at least in part on the first maximum rank and the first quantity of SRS resources, and wherein the second SRI indicates up to a second maximum quantity of SRS resources from the second SRS resource set, wherein the second maximum quantity is based at least in part on the second maximum rank and the second quantity of SRS resources.
Aspect 21: The method of any of Aspects 19-20, wherein the first SRI and the second SRI jointly indicate: the first one or more SRS resources and the second one or more SRS resources, from the first SRS resource set, based at least in part on the dynamic switching indicator being associated with a first value, or the first one or more SRS resources and the second one or more resources, from the second SRS resource set, based at least in part on the dynamic switching indicator being associated with a second value.
Aspect 22: The method of Aspect 21, wherein a first maximum quantity associated with the first one or more SRS resources and the second one or more SRS resources from the first SRS resource set is based at least in part on the maximum rank, the first maximum rank, the second maximum rank, and the first quantity of SRS resources, and wherein a second maximum quantity associated with the first one or more SRS resources and the second one or more SRS resources from the second SRS resource set is based at least in part on the maximum rank, the first maximum rank, the second maximum rank, and the second quantity of SRS resources.
Aspect 23: A method of wireless communication performed by a base station, comprising: transmitting, to a user equipment (UE), configuration information associated with a first sounding reference signal (SRS) resource set and a second SRS resource set, wherein the first SRS resource set includes a first quantity of SRS resources and the second SRS resource set includes a second quantity of SRS resources; and transmitting, to the UE, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.
Aspect 24: The method of Aspect 23, further comprising: receiving, from the UE, the spatial division multiplexing PUSCH communication using the first one or more SRS resources for the first one or more layers and the second one or more SRS resources for the second one or more layers.
Aspect 25: The method of Aspect 24, wherein transmitting the spatial division multiplexing PUSCH communication comprises: receiving the first one or more layers using a first beam or a first set of transmission parameters associated with the first one or more SRS resources; and receiving the second one or more layers using a second beam or a second set of transmission parameters associated with the second one or more SRS resources.
Aspect 26: The method of any of Aspects 23-25, wherein the spatial division multiplexing PUSCH communication is a non-codebook based PUSCH communication.
Aspect 27: The method of any of Aspects 23-26, wherein the first SRI and the second SRI are associated with an aggregated size that is based at least in part on: a first quantity of bits that is based at least in part on the first quantity of SRS resources and the maximum rank, or a second quantity of bits that is based at least in part on the second quantity of SRS resources and the maximum rank.
Aspect 28: The method of any of Aspects 23-27, wherein the first SRI and the second SRI jointly indicate: the first one or more SRS resources and the second one or more SRS resources, from the first SRS resource set, based at least in part on the dynamic switching indicator being associated with a first value, or the first one or more SRS resources and the second one or more SRS resources, from the second SRS resource set, based at least in part on the dynamic switching indicator being associated with a second value.
Aspect 29: The method of Aspect 28, wherein a quantity of the first one or more SRS resources and the second one or more SRS resources from the first SRS resource set is based at least in part on the first quantity of SRS resources and the maximum rank; and wherein a quantity of the first one or more SRS resources and the second one or more SRS resources from the second SRS resource set is based at least in part on the second quantity of SRS resources and the maximum rank.
Aspect 30: The method of any of Aspects 23-29, wherein the DCI indicates SRS resources from both the first SRS resource set and the second SRS resource set; and wherein the DCI indicates up to a first maximum quantity of SRS resources from a first subset of SRS resources, of the first SRS resource set, and up to a second maximum quantity of SRS resources from a second subset of SRS resources of the second SRS resource set.
Aspect 31: The method of Aspect 30, wherein a quantity of SRS resources included in the first subset of SRS resources is based at least in part on the first quantity of SRS resources and a portion of the maximum rank; and wherein a quantity of SRS resources included in the second subset of SRS resources is based at least in part on the second quantity of SRS resources and the portion of the maximum rank.
Aspect 32: The method of any of Aspects 23-31, wherein the first SRI indicates the first one or more SRS resources, from a first subset of SRS resources of the first SRS resource set, associated with the first one or more layers; and wherein the second SRI indicates the second one or more SRS resources, from a second subset of SRS resources of the second SRS resource set, associated with the second one or more layers.
Aspect 33: The method of Aspect 32, wherein the first SRI indicates up to a first maximum quantity of SRS resources from the first subset of SRS resources; and wherein the second SRI indicates up to a second maximum quantity of SRS resources from the second subset of SRS resources.
Aspect 34: The method of any of Aspects 23-33, wherein the first SRI and the second SRI are associated with an aggregated size that is based at least in part on: a first quantity of bits that is based at least in part on the first quantity of SRS resources and the maximum rank, a second quantity of bits that is based at least in part on the second quantity of SRS resources and the maximum rank, or a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank.
Aspect 35: The method of any of Aspects 23-34, wherein the configuration information indicates a third SRS resource set and a fourth SRS resource set, wherein a first set of SRS resources included in the first SRS resource set is included in the third SRS resource set, and wherein a second set of SRS resources included in the second SRS resource set is included in the fourth SRS resource set.
Aspect 36: The method of Aspect 35, wherein a quantity of SRS resources included in the first set of SRS resources is based at least in part on the first quantity of SRS resources and a portion of the maximum rank; and wherein a quantity of SRS resources included in the second set of SRS resources is based at least in part on the second quantity of SRS resources and the portion of the maximum rank.
Aspect 37: The method of any of Aspects 23-36, wherein the DCI indicates SRS resources from both the first SRS resource set and the second SRS resource set; and wherein the DCI indicates up to a first maximum quantity of SRS resources from the first SRS resource set and up to a second maximum quantity of SRS resources from the second SRS resource set.
Aspect 38: The method of Aspect 37, wherein the first maximum quantity of SRS resources is based at least in part on the first quantity of SRS resources and a portion of the maximum rank; and wherein the second maximum quantity of SRS resources is based at least in part on the second quantity of SRS resources and the portion of the maximum rank.
Aspect 39: The method of any of Aspects 23-38, wherein the first SRI indicates the first one or more SRS resources, from the first SRS resource set, associated with the first one or more layers, and wherein the second SRI indicates the second one or more SRS resources, from the second SRS resource set, associated with the second one or more layers.
Aspect 40: The method of Aspect 39, wherein the first SRI indicates up to a first maximum quantity of SRS resources from the first SRS resource set; and wherein the second SRI indicates up to a second maximum quantity of SRS resources from the second SRS resource set.
Aspect 41: The method of any of Aspects 23-40, wherein the first SRS resource set is associated with a first maximum rank and the second SRS resource set is associated with a second maximum rank.
Aspect 42: The method of Aspect 41, wherein the first SRI indicates up to a first maximum quantity of SRS resources from the first SRS resource set, wherein the first maximum quantity is based at least in part on the first maximum rank and the first quantity of SRS resources, and wherein the second SRI indicates up to a second maximum quantity of SRS resources from the second SRS resource set, wherein the second maximum quantity is based at least in part on the second maximum rank and the second quantity of SRS resources.
Aspect 43: The method of any of Aspects 41-42, wherein the first SRI and the second SRI jointly indicate: the first one or more SRS resources and the second one or more SRS resources, from the first SRS resource set, based at least in part on the dynamic switching indicator being associated with a first value, or the first one or more SRS resources and the second one or more SRS resources, from the second SRS resource set, based at least in part on the dynamic switching indicator being associated with a second value.
Aspect 44: The method of Aspect 43, wherein a first maximum quantity associated with the first one or more SRS resources and the second one or more SRS resources from the first SRS resource set is based at least in part on the maximum rank, the first maximum rank, the second maximum rank, and the first quantity of SRS resources, and wherein a second maximum quantity associated with the first one or more SRS resources and the second one or more SRS resources from the second SRS resource set is based at least in part on the maximum rank, the first maximum rank, the second maximum rank, and the second quantity of SRS resources.
Aspect 45: An apparatus for wireless communication at a device, comprising a processor; memory coupled with the processor; and instructions stored in the memory and executable by the processor to cause the apparatus to perform the method of one or more of Aspects 1-22.
Aspect 46: A device for wireless communication, comprising a memory and one or more processors coupled to the memory, the one or more processors configured to perform the method of one or more of Aspects 1-22.
Aspect 47: An apparatus for wireless communication, comprising at least one means for performing the method of one or more of Aspects 1-22.
Aspect 48: A non-transitory computer-readable medium storing code for wireless communication, the code comprising instructions executable by a processor to perform the method of one or more of Aspects 1-22.
Aspect 49: A non-transitory computer-readable medium storing a set of instructions for wireless communication, the set of instructions comprising one or more instructions that, when executed by one or more processors of a device, cause the device to perform the method of one or more of Aspects 1-22.
Aspect 50: An apparatus for wireless communication at a device, comprising a processor; memory coupled with the processor; and instructions stored in the memory and executable by the processor to cause the apparatus to perform the method of one or more of Aspects 23-44.
Aspect 51: A device for wireless communication, comprising a memory and one or more processors coupled to the memory, the one or more processors configured to perform the method of one or more of Aspects 23-44.
Aspect 52: An apparatus for wireless communication, comprising at least one means for performing the method of one or more of Aspects 23-44.
Aspect 53: A non-transitory computer-readable medium storing code for wireless communication, the code comprising instructions executable by a processor to perform the method of one or more of Aspects 23-44.
Aspect 54: A non-transitory computer-readable medium storing a set of instructions for wireless communication, the set of instructions comprising one or more instructions that, when executed by one or more processors of a device, cause the device to perform the method of one or more of Aspects 23-44.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory; and
one or more processors, coupled to the memory, configured to:
receive, from a base station, configuration information associated with a first sounding reference signal (SRS) resource set and a second SRS resource set, wherein the first SRS resource set includes a first quantity of SRS resources and the second SRS resource set includes a second quantity of SRS resources; and
receive, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.

2. The UE of claim 1, wherein the one or more processors are further configured to:
transmit the spatial division multiplexing PUSCH communication using the first one or more SRS resources for the first one or more layers and the second one or more SRS resources for the second one or more layers.

3. The UE of claim 2, wherein the one or more processors, to transmit the spatial division multiplexing PUSCH communication, are configured to:
transmit the first one or more layers using a first beam or a first set of transmission parameters associated with the first one or more SRS resources; and
transmit the second one or more layers using a second beam or a second set of transmission parameters associated with the second one or more SRS resources.

4. The UE of claim 1, wherein the spatial division multiplexing PUSCH communication is a non-codebook based PUSCH communication.

5. The UE of claim 1, wherein the first SRI and the second SRI are associated with an aggregated size that is based at least in part on:
a first quantity of bits that is based at least in part on the first quantity of SRS resources and the maximum rank, or
a second quantity of bits that is based at least in part on the second quantity of SRS resources and the maximum rank.

6. The UE of claim 1, wherein the first SRI and the second SRI jointly indicate:
the first one or more SRS resources and the second one or more SRS resources, from the first SRS resource set, based at least in part on the dynamic switching indicator being associated with a first value, or
the first one or more SRS resources and the second one or more SRS resources, from the second SRS resource set, based at least in part on the dynamic switching indicator being associated with a second value.

7. The UE of claim 1, wherein the DCI indicates SRS resources from both the first SRS resource set and the second SRS resource set; and wherein the DCI indicates up to a first maximum quantity of SRS resources from a first subset of SRS resources, of the first SRS resource set, and up to a second maximum quantity of SRS resources from a second subset of SRS resources of the second SRS resource set.

8. The UE of claim 1, wherein the first SRI indicates the first one or more SRS resources, from a first subset of SRS resources of the first SRS resource set, associated with the first one or more layers, and
wherein the second SRI indicates the second one or more SRS resources, from a second subset of SRS resources of the second SRS resource set, associated with the second one or more layers.

9. The UE of claim 1, wherein the first SRI and the second SRI are associated with an aggregated size that is based at least in part on:
a first quantity of bits that is based at least in part on the first quantity of SRS resources and the maximum rank,
a second quantity of bits that is based at least in part on the second quantity of SRS resources and the maximum rank, or
a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank.

10. The UE of claim 1, wherein the configuration information indicates a third SRS resource set and a fourth SRS resource set, wherein a first set of SRS resources included in the first SRS resource set is included in the third SRS resource set, and wherein a second set of SRS resources included in the second SRS resource set is included in the fourth SRS resource set.

11. The UE of claim 1, wherein the DCI indicates SRS resources from both the first SRS resource set and the second SRS resource set; and wherein the DCI indicates up to a first maximum quantity of SRS resources from the first SRS resource set and up to a second maximum quantity of SRS resources from the second SRS resource set.

12. The UE of claim 1, wherein the first SRI indicates the first one or more SRS resources, from the first SRS resource set, associated with the first one or more layers, and
wherein the second SRI indicates the second one or more SRS resources, from the second SRS resource set, associated with the second one or more layers.

13. The UE of claim 1, wherein the first SRS resource set is associated with a first maximum rank and the second SRS resource set is associated with a second maximum rank.

14. The UE of claim 13, wherein the first SRI indicates up to a first maximum quantity of SRS resources from the first SRS resource set, wherein the first maximum quantity is based at least in part on the first maximum rank and the first quantity of SRS resources, and
wherein the second SRI indicates up to a second maximum quantity of SRS resources from the second SRS resource set, wherein the second maximum quantity is based at least in part on the second maximum rank and the second quantity of SRS resources.

15. The UE of claim 13, wherein the first SRI and the second SRI jointly indicate:
the first one or more SRS resources and the second one or more SRS resources from the first SRS resource set based at least in part on the dynamic switching indicator being associated with a first value, or
the first one or more SRS resources and the second one or more SRS resources from the second SRS resource set based at least in part on the dynamic switching indicator being associated with a second value.

16. A method of wireless communication performed by a user equipment (UE), comprising:
receiving, from a base station, configuration information associated with a first sounding reference signal (SRS) resource set and a second SRS resource set, wherein the first SRS resource set includes a first quantity of SRS resources and the second SRS resource set includes a second quantity of SRS resources; and
receiving, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.

17. The method of claim 16, further comprising:
transmitting the spatial division multiplexing PUSCH communication using the first one or more SRS resources for the first one or more layers and the second one or more SRS resources for the second one or more layers.

18. The method of claim 16, wherein the spatial division multiplexing PUSCH communication is a non-codebook based PUSCH communication.

19. The method of claim 16, wherein the first SRI and the second SRI are associated with an aggregated size that is based at least in part on:
a first quantity of bits that is based at least in part on the first quantity of SRS resources and the maximum rank, or
a second quantity of bits that is based at least in part on the second quantity of SRS resources and the maximum rank.

20. The method of claim 16, wherein the first SRI and the second SRI jointly indicate:
the first one or more SRS resources and the second one or more SRS resources, from the first SRS resource set, based at least in part on the dynamic switching indicator being associated with a first value, or
the first one or more SRS resources and the second one or more SRS resources, from the second SRS resource set, based at least in part on the dynamic switching indicator being associated with a second value.

21. The method of claim 16, wherein the DCI indicates SRS resources from both the first SRS resource set and the second SRS resource set; and wherein the DCI indicates up to a first maximum quantity of SRS resources from a first subset of SRS resources, of the first SRS resource set, and up to a second maximum quantity of SRS resources from a second subset of SRS resources of the second SRS resource set.

22. The method of claim 16, wherein the first SRI indicates the first one or more SRS resources, from a first subset of SRS resources of the first SRS resource set, associated with the first one or more layers, and
wherein the second SRI indicates the second one or more SRS resources, from a second subset of SRS resources of the second SRS resource set, associated with the second one or more layers.

23. The method of claim 16, wherein the first SRI and the second SRI are associated with an aggregated size that is based at least in part on:
a first quantity of bits that is based at least in part on the first quantity of SRS resources and the maximum rank,
a second quantity of bits that is based at least in part on the second quantity of SRS resources and the maximum rank, or
a third quantity of bits that is based at least in part on a combination of a fourth quantity of bits that is based at least in part on the first quantity of SRS resources and a portion of the maximum rank and a fifth quantity of bits that is based at least in part on the second quantity of SRS resources and the portion of the maximum rank.

24. The method of claim 16, wherein the configuration information indicates a third SRS resource set and a fourth SRS resource set, wherein a first set of SRS resources included in the first SRS resource set is included in the third SRS resource set, and wherein a second set of SRS resources included in the second SRS resource set is included in the fourth SRS resource set.

25. The method of claim 16, wherein the DCI indicates SRS resources from both the first SRS resource set and the second SRS resource set; and wherein the DCI indicates up to a first maximum quantity of SRS resources from the first SRS resource set and up to a second maximum quantity of SRS resources from the second SRS resource set.

26. The method of claim 16, wherein the first SRI indicates the first one or more SRS resources, from the first SRS resource set, associated with the first one or more layers, and
wherein the second SRI indicates the second one or more SRS resources, from the second SRS resource set, associated with the second one or more layers.

27. The method of claim 16, wherein the first SRS resource set is associated with a first maximum rank and the second SRS resource set is associated with a second maximum rank.

28. The method of claim 27, wherein the first SRI indicates up to a first maximum quantity of SRS resources from the first SRS resource set, wherein the first maximum quantity is based at least in part on the first maximum rank and the first quantity of SRS resources, and
wherein the second SRI indicates up to a second maximum quantity of indicated SRS resources from the second SRS resource set, wherein the second maximum quantity is based at least in part on the second maximum rank and the second quantity of SRS resources.

29. A non-transitory computer-readable medium storing a set of instructions for wireless communication, the set of instructions comprising:
one or more instructions that, when executed by one or more processors of a user equipment (UE), cause the UE to:
receive, from a base station, configuration information associated with a first sounding reference signal (SRS) resource set and a second SRS resource set, wherein the first SRS resource set includes a first quantity of SRS resources and the second SRS resource set includes a second quantity of SRS resources; and
receive, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.

30. An apparatus for wireless communication, comprising:
means for receiving, from a base station, configuration information associated with a first sounding reference signal (SRS) resource set and a second SRS resource set, wherein the first SRS resource set includes a first quantity of SRS resources and the second SRS resource set includes a second quantity of SRS resources; and
means for receiving, from the base station, downlink control information (DCI) scheduling a spatial division multiplexing physical uplink shared channel (PUSCH) communication associated with a first one or more layers and a second one or more layers, wherein the DCI indicates a first one or more SRS resources associated with the first one or more layers and a second one or more SRS resources associated with the second one or more layers from at least one of the first SRS resource set or the second SRS resource set based at least in part on at least one of: a dynamic switching indicator included in the DCI, a first SRS resource indicator (SRI) included in the DCI, a second SRI included in the DCI, the first quantity of SRS resources, the second quantity of SRS resources, or a maximum rank associated with the spatial division multiplexing PUSCH communication.
